(19) United States
(12) Patent Application Publication
(10) Pub. No.: US 2014/0282800 A1
(43) Pub. Date: Sep. 18, 2014

(54) VIDEO PROCESSING DEVICE, VIDEO REPRODUCTION DEVICE, VIDEO PROCESSING METHOD, VIDEO REPRODUCTION METHOD, AND VIDEO PROCESSING SYSTEM

(71) Applicant: Sony Corporation, Tokyo (JP)

(72) Inventors: Takehiko Morita, Kanagawa (JP); Tatsuya Igarashi, Tokyo (JP); Atsushi Okamori, Tokyo (JP)

(73) Assignee: Sony Corporation, Tokyo (JP)

(21) Appl. No.: 14/203,856

(22) Filed: Mar. 11, 2014

(30) Foreign Application Priority Data
Mar. 18, 2013 (JP) 2013-054995

(51) Int. Cl. H04N 21/6332; H04N 21/4402; H04N 21/2343

(52) U.S. Cl. CPC H04N 21/6332; H04N 21/234363; H04N 21/440263
USPC 725/119

(57) ABSTRACT

According to an embodiment of the present disclosure, there is provided a video processing device including an image generation unit configured to generate a second moving image configured to have the same content as a first moving image having first image quality, to have second image quality configured to be higher quality than the first image quality, and to have a size corresponding to a partial region of the first moving image, and a reproduction information generation unit configured to generate reproduction information configured to be used to simultaneously reproduce the first moving image and the second moving image after a portion of the first moving image is replaced with the second moving image.

### CROSS REFERENCE TO RELATED APPLICATIONS

This application claims the benefit of Japanese Priority Patent Application JP 2013-054995 filed Mar. 18, 2013, the entire contents of which are incorporated herein by reference.

### BACKGROUND

The present disclosure relates to a video processing device, a video reproduction device, a video processing method, a video reproduction method, and a video processing system.

There are a number of proposed technologies for reproducing a moving image with improved image quality. For example, JP 2010-11448A and the like disclose a technology for improving quality of a reproduced moving image by analyzing encoded information and pixel information of a single unit of the reproduced moving image. In addition, JP 2011-193117A and the like disclose a technology for improving quality of a reproduced moving image by performing frame interpolation on a plurality of different moving images.

### SUMMARY

When a moving image distributed from a server is received via a network and reproduced in a client terminal, quality of the reproduced moving image is decided depending on a processing capability of the client terminal, a screen size, or a transmission rate of the network. For this reason, if the client terminal does not have a sufficient processing capability, the moving image with high image quality is difficult to reproduce, and if the transmission rate of the network is not high even though it is intended to reproduce the moving image with high quality using a sufficient processing capability of the client terminal, reproduction of the moving image with high quality is difficult as well. Therefore, when the processing capability of the client terminal and the transmission rate of the network are not sufficient, it is difficult to enhance a viewing experience of a user.

Thus, it is desirable for the present disclosure to provide a novel and improved video processing device, video reproduction device, video processing method, video reproduction method, and video processing system that can enhance a viewing experience of a user even when a processing capability of a client terminal and a transmission rate of a network are not sufficient.

According to an embodiment of the present disclosure, there is provided a video processing device including an image generation unit configured to generate a second moving image configured to have the same content as a first moving image having first image quality, to have second image quality configured to be higher quality than the first image quality, and to have a size corresponding to a partial region of the first moving image, and a reproduction information generation unit configured to generate reproduction information configured to be used to simultaneously reproduce the first moving image and the second moving image after a portion of the first moving image is replaced with the second moving image.

According to an embodiment of the present disclosure, there is provided a video reproduction device including an image acquisition unit configured to acquire a first moving image configured to have first image quality, a second moving image configured to have a same content as the first moving image, to have second image quality configured to be higher quality than the first image quality, and to have a size corresponding to a partial region of the first moving image, and reproduction information used to simultaneously reproduce the first moving image and the second moving image after a portion of the first moving image is replaced with the second moving image, and an image combining unit configured to cause the first moving image and the second moving image to be simultaneously reproduced after the portion of the first moving image is replaced with the second moving image based on the reproduction information acquired by the image acquisition unit.

According to an embodiment of the present disclosure, there is provided a video processing method including generating a second moving image configured to have a same content as a first moving image having first image quality, to have second image quality configured to be higher quality than the first image quality, and to have a size corresponding to a partial region of the first moving image, and generating reproduction information used to simultaneously reproduce the first moving image and the second moving image after a portion of the first moving image is replaced with the second moving image.

According to an embodiment of the present disclosure, there is provided a video reproduction method including acquiring a first moving image configured to have first image quality, a second moving image configured to have a same content as the first moving image, to have second image quality configured to be higher quality than the first image quality, and to have a size corresponding to a partial region of the first moving image, and reproduction information used to simultaneously reproduce the first moving image and the second moving image after a portion of the first moving image is replaced with the second moving image, and simultaneously reproducing the first moving image and the second moving image after the portion of the first moving image is replaced with the second moving image based on the reproduction information acquired in the acquisition step.

According to an embodiment of the present disclosure, there is provided a video processing system including a video processing device, and a video reproduction device. The video processing device includes an image generation unit configured to generate a second moving image configured to have a same content as a first moving image having first image quality, to have second image quality configured to be higher quality than the first image quality, and to have a size corresponding to a partial region of the first moving image; and a reproduction information generation unit configured to generate reproduction information used to simultaneously reproduce the first moving image and the second moving image after a portion of the first moving image is replaced with the second moving image. The video reproduction device includes an image acquisition unit configured to acquire at least the second moving image and the reproduction information from the video processing device; and an image reproduction unit configured to simultaneously reproduce the first moving image and the second moving image after the portion of the first moving image is replaced with the second moving image based on the reproduction information acquired by the image acquisition unit.

According to an embodiment of the present disclosure as described above, it is possible to provide a novel and improved video processing device, video reproduction device, video processing method, video reproduction method, and video processing system that can enhance viewing experience of a user even when a processing capability of a client terminal and a transmission rate of a network are not sufficient.

### BRIEF DESCRIPTION OF THE DRAWINGS

FIG. 1 is a descriptive diagram showing an overall configuration example of a moving image reproduction system 1 according to an embodiment of the present disclosure;

FIG. 2 is a descriptive diagram showing a functional configuration example of an interpolation moving image generation unit 120 according to an embodiment of the present disclosure;

FIG. 3 is a descriptive diagram showing a functional configuration example of an interpolation moving image transmission unit 130 according to an embodiment of the present disclosure;

FIG. 4 is a descriptive diagram showing a functional configuration example of an interpolation unit 210 included in a reproduction device 200 according to an embodiment of the present disclosure;

FIG. 5 is a flowchart showing an operation example of the interpolation moving image generation unit 120 according to an embodiment of the present disclosure;

FIG. 6 is a flowchart showing an operation example of the interpolation moving image transmission unit 130 according to an embodiment of the present disclosure;

FIG. 7 is a flowchart showing another operation example of the interpolation moving image transmission unit 130 according to the embodiment of the present disclosure;

FIG. 8 is a flowchart showing an operation example of the interpolation unit 210 included in the reproduction device 200 according to an embodiment of the present disclosure;

FIG. 9 is a flowchart showing another operation example of the interpolation unit 210 included in the reproduction device 200 according to the embodiment of the present disclosure;

FIG. 10 is a descriptive diagram showing moving image data groups retained by a reproduction moving image transmission unit 110, the interpolation moving image generation unit 120, and the interpolation moving image transmission unit 130;

FIG. 11 is a descriptive diagram showing enlargement and reduction processes of a generated moving image and an interpolated moving image;

FIG. 12 is a descriptive diagram showing a functional configuration example of the interpolation unit 210 according to Example 1 of an embodiment of the present disclosure;

FIG. 13 is a flowchart showing an operation example of the interpolation moving image generation unit 120 according to Example 1;

FIG. 14 is a flowchart showing the operation example of the interpolation moving image generation unit 120 according to Example 1;

FIG. 15 is a flowchart showing the operation example of the interpolation moving image generation unit 120 according to Example 1;

FIG. 16 is a flowchart showing an operation example of an interpolation processing section 218 included in the interpolation unit 210 according to Example 1;

FIG. 17 is a descriptive diagram showing an example of changes of the image size of an interpolation region and a moving image screen of an interpolation moving image v12 according to Example 1;

FIG. 18 is a descriptive diagram showing the relationship between the moving image screen of the interpolation moving image v12 and the coordinates of the interpolation region;

FIG. 19 is a descriptive diagram showing a process performed when the interpolation unit 210 extracts an image of the interpolation region from the moving image screen of the interpolation moving image v12;

FIG. 20 is a flowchart showing an operation example of the interpolation moving image generation unit 120 according to Example 2;

FIG. 21 is a flowchart showing the operation example of the interpolation moving image generation unit 120 according to Example 2;

FIG. 22 is a flowchart showing the operation example of the interpolation moving image generation unit 120 according to Example 2;

FIG. 23 is a flowchart showing an operation example of the interpolation unit 210 according to Example 2;

FIG. 24 is a descriptive diagram showing an example of the relationship between a moving image screen of the interpolation moving image v12 and interpolation regions according to Example 2;

FIG. 25 is a flowchart showing an operation example of the interpolation moving image generation unit 120 performed when the content of Example 2 is applied to Example 1;

FIG. 26 is a descriptive diagram showing effects exhibited when the content of Example 2 is applied to Example 1;

FIG. 27 is a descriptive diagram showing a functional configuration example of the interpolation moving image generation unit 120 according to Example 3 of an embodiment of the present disclosure;

FIG. 28 is a descriptive diagram showing a functional configuration example of the interpolation moving image transmission unit 130 according to Example 3 of the embodiment of the present disclosure;

FIG. 29 is a descriptive diagram showing a functional configuration example of the interpolation unit 210 according to Example 3 of the embodiment of the present disclosure;

FIG. 30 is a descriptive diagram showing an operation example of the interpolation moving image generation unit 120 according to Example 3 of the embodiment of the present disclosure;

FIG. 31 is a descriptive diagram showing an operation example of the interpolation unit 210 according to Example 3 of the embodiment of the present disclosure;

FIG. 32 is a descriptive diagram showing an overview of an operation of Example 3;

FIG. 33 is a descriptive diagram showing an overview of another operation of Example 3; and

FIG. 34 is a descriptive diagram showing an overview of still another operation of Example 3.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Description will be provided in the following order.

<1. An embodiment of the present disclosure>

[Overview]

[Overall configuration example]

[Functional configuration example of an interpolated moving image generation unit]

[Functional configuration example of an interpolated moving image transmission unit]

[Functional configuration example of an interpolation unit]

[Operation example of the interpolated moving image generation unit]

[Operation example of the interpolated moving image transmission unit]

[Operation example of the interpolation unit]

[Conclusion]

<2. Example 1>

<3. Example 2>

<4. Example 3>

<5. Conclusion>

### 1. AN EMBODIMENT OF THE PRESENT DISCLOSURE

### [Overview]

An overview of the present disclosure will be described before detailed description of an embodiment of the present disclosure is provided.

Resolution of a displayed screen of a moving image reproduction device that reproduces moving images has become higher. On the other hand, there is a problem that quality of resolution of moving images distributed through network streaming, broadcasting waves, and other transmission media is not appropriate for resolution of a displayed screen of a moving image reproduction device at all times.

Even when resolution of display of a moving image reproduction device is so-called HD, 4K, or 2K, for example, it is necessary to encode a moving image with the resolution at a high encoding rate to encode and transmit the moving image while maintaining the quality thereof. Regardless of wired or wireless transmission, there are cases in which it is difficult to transmit an encoded moving image at such a high encoding rate in real time due to a transmission rate of a communication line.

In addition, there is also a case in which a moving image reproduction device has an insufficient decoding capability, and in such a case, it takes time to decode a moving image encoded at a high encoding rate. In this case, a moving image which is transmitted with low resolution is received at a low encoding rate and then enlarged so as to fit to the size of a display screen of a moving image reproduction device. In addition, when moving images such as content of which resolution for mobile devices or an encoding rate is lowered in moving image streams for one-segment broadcasting or for mobile devices, which are distributed to devices that are basically provided with small screens, are reproduced in a device such as a tablet or a television provided with a large screen, the moving images are enlarged and displayed in the same manner. If a reproduced moving image suitable for a screen in a small size is enlarged and reproduced on a screen in a large size, quality of the reproduced image deteriorates.

With regard to this problem, there is a technology for reducing the degree of deterioration of a moving image when the image is enlarged for a screen by analyzing the received reproduced moving image and performing computation for up-conversion thereon in a moving image reproduction device. However, in the computation based on a moving image that basically has a small amount of information for a small screen, there is a limitation on improvement of image quality, a calculation process is a burden on the reproduction device, or it is necessary to mount an independent circuit for the computation.

On the other hand, a moving image streaming system, in which many moving image distribution servers provided on the Internet prepare groups of moving image files that are provided in a plurality of image sizes and encoded a plurality of encoding rates for one piece of moving image content and a reproduction device selects a moving image file having an image size and a encoding rate according to a transmission rate or a reproduction capability, has been widely used.

However, in the streaming system, image sizes and encoding rates that can be selected are decided in advance, and thus it is not possible to designate an arbitrary image size or encoding rate. For example, when a distribution server provides moving image files having transmission rates of 1 Mbps, 3 Mbps, and 5 Mbps and a communication rate of a moving image reproduction device is 4 Mbps, if the moving image reproduction device selects and receives a moving image of 3 Mbps, the device can reproduce the moving image with the highest image quality, but the transmission band of 1 Mbps is not used.

If only a partial region of a screen is made to provide high image quality when a moving image to be reproduced for a screen in a small size is enlarged and reproduced, there are many cases in which a viewing experience of a user can be enhanced. For example, if a region in a moving image, for example, a ball or a player in sport broadcasting, the face of an actor in a movie, or the like, of which recognition can be improved, or only a region in the moving image that is considered to be important is made to have high image quality, a viewing experience of a user is enhanced in many cases.

Therefore, according to an embodiment of the present disclosure, a server generates a moving image of a partial screen having high image quality in which only a partial region of a screen is set to be a moving image with high image quality. In the present embodiment, such a moving image of a partial screen having high image quality is called an “interpolation moving image.” The server transmits a generated interpolation moving image to a moving image reproduction device. When a moving image having low image quality is enlarged and reproduced, an interpolation moving image of a partial screen having high quality is synthesized therewith and reproduced at the same time. In the present embodiment, a process of synthesizing an interpolation moving image of a partial screen having high image quality performed when a moving image having low image quality is enlarged and reproduced is called an “interpolation process.” In an embodiment of the present disclosure to be described hereinbelow, a viewing experience of a user can be enhanced by making a partial region of a screen have high image quality even when a moving image having low image quality is enlarged and reproduced.

A distribution side of moving images creates high-quality moving images that have high resolution and are encoded at a high encoding rate in advance and retains the images as original moving images that serve as bases of reproduction moving images (having low image quality) to be distributed. The distribution side of moving images considers a communication band or a capability of a moving image reproduction device, thereby creating and distributing a reproduced moving image of which resolution or an encoding rate is lowered based on a moving image having high image quality.

An original moving image with high image quality and a distributed and reproduced moving image are moving image items (moving image files or the like) which have the same moving image content and have different image sizes and encoding rates based on the same content. Thus, both moving images are set to have the same content name (title or the like) or the same internal management identifier or to be managed so as to be associated with each other. A user can identify that the reproduced moving image (with low image quality) and the original moving image with high image quality are associated with each other in terms of the same content with reference to the content name (title or the like) of both moving images, and a moving image reproduction device can associate both of the moving images using the internal management identifier.

Hereinabove, an overview of the present disclosure has been described. Next, an overall configuration example of a moving image reproduction system according to an embodiment of the present disclosure will be described.

### [Overall Configuration Example]

FIG. 1 is a descriptive diagram showing an overall configuration example of the moving image reproduction system according to an embodiment of the present disclosure. Hereinafter, the overall configuration example of the moving image reproduction system 1 according to the embodiment of the present disclosure will be described with reference to FIG. 1.

As shown in FIG. 1, the moving image reproduction system 1 according to the embodiment of the present disclosure is configured to include a reproduction moving image transmission unit 110, an interpolation moving image generation unit 120, an interpolation moving image transmission unit 130, and a reproduction device 200. The reproduction moving image transmission unit 110, the interpolation moving image generation unit 120, and the interpolation moving image transmission unit 130 are elements on a distribution side of moving images, and the elements may be provided in the same device, or may be connected to one another via a transmission path such as a network. When the elements are connected to one another via transmission paths such as a network, the transmission paths may be the same or different. For example, all of the reproduction moving image transmission unit 110, the interpolation moving image generation unit 120, and the interpolation moving image transmission unit 130 may be connected to one another on the same network or on different transmission paths such that a transmission path between the reproduction moving image transmission unit 110 and the reproduction device 200 is broadcasting waves and a transmission path between the interpolation moving image transmission unit 130 and the reproduction device 200 is a network.

In description to be provided below, the reproduction moving image transmission unit 110, the interpolation moving image generation unit 120, and the interpolation moving image transmission unit 130 are set to be connected to one another via a transmission path such as a network as shown in FIG. 1, however, the present disclosure is not limited to the example.

FIG. 10 is a descriptive diagram showing moving image data groups retained by the reproduction moving image transmission unit 110, the interpolation moving image generation unit 120, and the interpolation moving image transmission unit 130. The reproduction moving image transmission unit 110, the interpolation moving image generation unit 120, and the interpolation moving image transmission unit 130 will be described with reference also to the moving image data groups shown in FIG. 10.

The reproduction moving image transmission unit 110 transmits a reproduction moving image v10 to the reproduction device 200 via the transmission path such as a network or broadcasting waves. The reproduction moving image v10 is transmitted to all clients, and configured as a moving image file to be reproduced in the clients. The reproduction moving image v10 transmitted from the reproduction moving image transmission unit 110 can be received, reproduced, or stored by the reproduction device 200.

The interpolation moving image generation unit 120 retains a high-quality moving image v11 of which content is the same as that of the reproduction moving image v10 and the quality is higher than that of the reproduction moving image v10. Note that quality being high means that an image size is large or an encoding rate is high. The high-quality moving image v11 is configured as a moving image file of which content is the same as that of the reproduction moving image v10 and quality such as an image size or an encoding rate is high. The high-quality moving image v11 is a moving image that serves as the base of the reproduction moving image v10. The reproduced moving image and the high-quality moving image can be associated by a user or in a system based on display names, internal management identifiers, or the like. The interpolation moving image generation unit 120 decides an interpolation region in the moving image to be reproduced in the reproduction device 200, extracts the interpolation region from the high-quality moving image v11, and generates an interpolation moving image v12 and interpolation information i10. The interpolation moving image generation unit 120 can be, for example, a moving image authoring device provided by a service provider who distributes moving images or a server device provided on the network.

The interpolation moving image v12 is a moving image file that is obtained by extracting, from a moving image screen of the high-quality moving image v11, only an interpolation region which is a region with which recognition of content of the reproduction moving image v10 can improve or a region of the moving image considered to be important, in other words, a moving image of a partial screen of the high-quality moving image v11. The interpolation moving image v12 is configured as a moving image file that is obtained by extracting a partial image of an interpolation region instructed by information retained by an interpolation instruction unit 121 to be described later from frame images of the high-quality moving image v11 and encoding the partial image as a frame image.

The interpolation information i10 is an example of reproduction information of the present disclosure. The interpolation information i10 is information generated by the interpolation moving image generation unit 120, and configured as a file in which the coordinates, the width, and the height of each frame image of the interpolation moving image v12 in the moving image screen of the original high-quality moving image v11 are indicated for each frame. The interpolation information i10 is generated based on the information retained by the interpolation instruction unit 121 to be described later. In addition, in the interpolation information i10, the overall image size of the original high-quality moving image v11 can also be recorded.

For one piece of moving image content (the reproduction moving image v10 and the high-quality moving image v11), a plurality of pieces of the interpolation moving image v12 and the interpolation information i10 may be created. For example, there may be a plurality of pieces of the interpolation moving image v12 and the interpolation information i10 such as the interpolation moving image v12 and the interpolation information i10 for interpolating a region of a player A and the interpolation moving image v12 and the interpolation information i10 for interpolating a region of a player B with regard to a sport moving image which is one piece of moving image content. In this manner, by creating the plurality of pieces of the interpolation moving image v12 and the interpolation information i10 for one moving image content item, a user can select one or a plurality of pieces of the interpolation moving image v12 and the interpolation information i10 of his or her favorite player and reproduce the moving image in the reproduction device 200. In addition, for example, the interpolation moving image v12 and the interpolation information i10 for interpolating a region in which text information (for example, a score) is displayed may be designed to be generated for a sport moving image that is one piece of moving image content.

The interpolation moving image generation unit 120 is configured to include the interpolation instruction unit 121 as shown in FIG. 1. The interpolation instruction unit 121 retains information that instructs which portion of the screen of the high-quality moving image v11 should be designated as an interpolation region. The screen of the high-quality moving image v11 is a screen having the same content as the reproduction moving image v10 and high quality in terms of an image size and an encoding rate. In the information retained by the interpolation instruction unit 121, the time of each frame and a frame number of the high-quality moving image v11, and the coordinates, the width, and the height of a region in each frame image to be instructed as an interpolation region are enumerated for each frame. The information retained by the interpolation instruction unit 121 can be, for example, a region which instructed by a user who reproduces the reproduction moving image v10 or a person on a distribution service provider side that distributes the reproduction moving image v10 (for example, an editor who edits the reproduction moving image v10 or a sport commentator who gives commentary on a sport game if the reproduction moving image v10 is a sport moving image) along times of the moving image and is made into a computer file, or a region which is automatically detected through moving image recognition and made into a computer file. The information retained by the interpolation instruction unit 121 can be supplied to the interpolation moving image transmission unit 130 as interpolation information i10.

FIG. 1 shows a moving image analysis unit 300 which executes moving image recognition. The moving image analysis unit 300 decides an interpolation region of each frame through moving image recognition and transfers information of the decided interpolation region to the interpolation instruction unit 121.

The interpolation moving image transmission unit 130 retains the interpolation moving image v12 and the interpolation information i10 generated by the interpolation moving image generation unit 120 and transmits the moving image and the information to the reproduction device 200 via a transmission path such as a network. The interpolation moving image transmission unit 130 can be, for example, a server device on the network.

The reproduction device 200 receives and reproduces the reproduction moving image v10 transmitted from the reproduction moving image transmission unit 110. In addition, the reproduction device 200 receives the interpolation moving image v12 and the interpolation information i10 transmitted from the interpolation moving image transmission unit 130 and reproduces the reproduction moving image v10 by replacing a part of the moving image with the interpolation moving image v12 using the interpolation information i10 at the time of reproducing the reproduction moving image v10.

As shown in FIG. 1, the reproduction device 200 is configured to include an interpolation unit 210 and a reproduction unit 220. The interpolation unit 210 receives the reproduction moving image v10 from the reproduction moving image transmission unit 110 and also receives the interpolation moving image v12 and the interpolation information i10 from the interpolation moving image transmission unit 130. The interpolation unit 210 causes an interpolation region of the reproduction moving image v10 to have high quality using the interpolation moving image v12 on the reproduction moving image v10, thereby generating an interpolated moving image v13. The reproduction unit 220 reproduces the interpolated moving image v13 generated by the interpolation unit 210. The interpolated moving image v13 reproduced by the reproduction unit 220 is displayed on a display screen (not shown).

The interpolation unit 210 and the reproduction unit 220 may be disposed inside the reproduction device 200 as shown in FIG. 1, or may be connected to each other on a transmission line such as a network.

Hereinabove, an overall configuration example of the moving image reproduction system 1 according to an embodiment of the present disclosure has been described with reference to FIG. 1. Next, a functional configuration example of the interpolation moving image generation unit 120 according to an embodiment of the present disclosure will be described.

[Functional Configuration Example of the Interpolation Moving Image Generation Unit]

FIG. 2 is a descriptive diagram showing a functional configuration example of the interpolation moving image generation unit 120 according to an embodiment of the present disclosure. Hereinafter, the functional configuration example of the interpolation moving image generation unit 120 according to the embodiment of the present disclosure will be described with reference to FIG. 2.

As shown in FIG. 2, the interpolation moving image generation unit 120 according to the embodiment of the present disclosure is configured to include an interpolation instruction unit 121, a decoding unit 122, an interpolation information processing unit 123, a frame image extraction unit 124, and an encoding unit 125.

The interpolation instruction unit 121 retains information that instructs which part of a screen of the high-quality moving image v11 should be set as an interpolation region as described above. The information retained by the interpolation instruction unit 121 is appropriately supplied to the interpolation information processing unit 123, if necessary.

The decoding unit 122 decodes the encoded high-quality moving image v11. When the high-quality moving image v11 is decoded, the decoding unit 122 transfers information of a time of each frame and the image size of the high-quality moving image v11 to the interpolation information processing unit 123, and transfers a frame image of a moving image screen of the high-quality moving image v11 to the frame image extraction unit 124.

The interpolation information processing unit 123 decides coordinates in which the interpolation moving image v12 is extracted (coordinates of a moving image screen of the interpolation moving image v12) and the size thereof for each frame of the high-quality moving image v11 based on the information retained by the interpolation instruction unit 121, and transfers the information of the coordinates and the size to the frame image extraction unit 124. In addition, the interpolation information processing unit 123 generates the interpolation information i10 from the information retained by the interpolation instruction unit 121. The interpolation information i10 generated by the interpolation information processing unit 123 is delivered to the interpolation moving image transmission unit 130.

The frame image extraction unit 124 extracts a pixel group (a partial image) of a region that the interpolation information processing unit 123 instructs from a decoded frame image of the high-quality moving image v11 given by the decoding unit 122, and sets the pixel group as a frame image of an interpolation moving image screen. The frame image of the interpolation moving image screen extracted by the frame image extraction unit 124 is delivered to the encoding unit 125.

The encoding unit 125 encodes the frame image of the interpolation moving image screen extracted by the frame image extraction unit 124 and generates the interpolation moving image v12. The interpolation moving image v12 generated by the encoding unit 125 is delivered to the interpolation moving image transmission unit 130.

The interpolation moving image generation unit 120 can generate the interpolation moving image v12 from the high-quality moving image v11 and generate the interpolation information i10 for interpolating the reproduction moving image v10 using the interpolation moving image v12 with the configuration shown in FIG. 2.

Hereinabove, the functional configuration example of the interpolation moving image generation unit 120 according to the embodiment of the present disclosure has been described with reference to FIG. 2. Next, a functional configuration example of the interpolation moving image transmission unit 130 according to an embodiment of the present disclosure will be described.

### [Functional Configuration Example of the Interpolation Moving Image Transmission Unit]

FIG. 3 is a descriptive diagram showing the functional configuration example of the interpolation moving image transmission unit 130 according to the embodiment of the present disclosure. Hereinafter, the functional configuration example of the interpolation moving image transmission unit 130 according to the embodiment of the present disclosure will be described with reference to FIG. 3.

As shown in FIG. 3, the interpolation moving image transmission unit 130 according to the embodiment of the present disclosure is configured to include a reception unit 131, an interpolation recording unit 132, an interpolation list management unit 133, and a transmission unit 134.

The reception unit 131 receives the interpolation moving image v12 and the interpolation information i10 generated by the interpolation moving image generation unit 120. When the interpolation moving image v12 and the interpolation information i10 generated by the interpolation moving image generation unit 120 are received, the reception unit 131 delivers the received interpolation moving image v12 and interpolation information i10 to the interpolation recording unit 132.

The interpolation recording unit 132 retains the interpolation moving image v12 and the interpolation information i10 delivered from the reception unit 131 in association. The interpolation recording unit 132 also retains information of which moving image content a pair of the interpolation moving image v12 and the interpolation information i10 relates to. When it is determined to which moving image content the pair of the interpolation moving image v12 and the interpolation information i10 relates, an identifier of moving image content described in the interpolation information i10 by the interpolation moving image generation unit 120 is used as will be described later. FIG. 3 shows an example of interpolation management information retained by the interpolation recording unit 132. Moving image content X includes information for interpolating a player A and a player B, and moving image content Y includes interpolation management information for interpolating a car a. In the interpolation management information, the interpolation moving image v12 is associated with the interpolation information i10.

The interpolation list management unit 133 returns a list of moving image content corresponding to an interpolation moving image group retained by the interpolation recording unit 132 according to an inquiry from the interpolation unit 210 of the reproduction device 200. In addition, when moving image content is designated by the interpolation unit 210, the interpolation list management unit 133 returns a list of pairs of the interpolation moving image v12 and the interpolation information i10 retained by the interpolation recording unit 132.

In the example shown in FIG. 3, the interpolation list management unit 133 returns content x and content y as a list of moving image content corresponding to the interpolation moving image group retained by the interpolation recording unit 132 according to an inquiry from the interpolation unit 210 of the reproduction device 200. In addition, in the example shown in FIG. 3, when the content X is designated in the reproduction device 200, the interpolation list management unit 133 returns the “player A” and “player B” as a list of the pairs of the interpolation moving image v12 and the interpolation information i10 present in the content X. In addition, when the reproduction device 200 instructs the pair of the interpolation moving image v12 and the interpolation information i10, the interpolation list management unit 133 instructs the transmission unit 134 to transmit the pair of the interpolation moving image v12 and the interpolation information i10.

The transmission unit 134 acquires, from the interpolation recording unit 132, the pair of the interpolation moving image v12 and the interpolation information i10 of which transmission is instructed by the interpolation list management unit 133 and transmits the pair to the reproduction device 200.

The interpolation moving image transmission unit 130 can transmit the interpolation moving image v12 generated from the high-quality moving image v11 and the interpolation information i10 for interpolating the reproduction moving image v10 using the interpolation moving image v12 to the reproduction device 200 with the configuration shown in FIG. 3.

Hereinabove, the functional configuration example of the interpolation moving image transmission unit 130 according to the embodiment of the present disclosure has been described with reference to FIG. 3. Next, a functional configuration example of the interpolation unit 210 included in the reproduction device 200 according to an embodiment of the present disclosure will be described.

### [Functional Configuration Example of the Interpolation Unit]

FIG. 4 is a descriptive diagram showing the functional configuration example of the interpolation unit 210 included in the reproduction device 200 according to the embodiment of the present disclosure. Hereinafter, the functional configuration example of the interpolation unit 210 included in the reproduction device 200 according to the embodiment of the present disclosure will be described with reference to FIG. 4.

As shown in FIG. 4, the interpolation unit 210 included in the reproduction device 200 according to the embodiment of the present disclosure is configured to include reception sections 211, 212, and 213, an interpolation moving image selection section 214, decoding sections 215 and 216, a time control section 217, and an interpolation processing section 218.

The reception sections 211, 212, and 213 are an example of an image acquisition unit of the present disclosure. The reception sections 211, 212, and 213 respectively receive the reproduction moving image v10, the interpolation moving image v12, and the interpolation information i10. The reproduction moving image v10 is transmitted from the reproduction moving image transmission unit 110, and the interpolation moving image v12 and the interpolation information i10 are transmitted from the interpolation moving image transmission unit 130. The reproduction moving image v10 that the reception section 211 receives is delivered to the decoding section 215, the interpolation moving image v12 that the reception section 212 receives is delivered to the decoding section 216, and the interpolation information i10 that the reception section 213 receives is delivered to the interpolation processing section 218.

In the example shown in FIG. 4, the reception sections 211, 212, and 213 are shown as separate constituent elements, however, the present disclosure is not limited to the example. The reception sections 211, 212, and 213 may be provided as one constituent element.

The interpolation moving image selection section 214 acquires, from the interpolation moving image transmission unit 130, a list of interpolation moving images corresponding to the reproduction moving image v10 received from the reproduction moving image transmission unit 110, and decides the interpolation moving image v12 and the interpolation information i10 used in interpolation of the reproduction moving image v10. The interpolation moving image v12 and the interpolation information i10 decided by the interpolation moving image selection section 214 are transmitted to the interpolation moving image transmission unit 130.

The decoding sections 215 and 216 respectively decode the reproduction moving image v10 and the interpolation moving image v12 in an encoded state for each frame, and then output frame images (pixel groups). The decoding sections 215 and 216 output the frame images of the reproduction moving image v10 and the interpolation moving image v12 to the interpolation processing section 218. In addition, the decoding sections 215 and 216 output frame times (frame numbers) of the frame images of the reproduction moving image v10 and the interpolation moving image v12.

The time control section 217 controls such that the frame time of the reproduction moving image v10 match that of the interpolation moving image v12 during an interpolation process performed in the interpolation processing section 218 using information of the frame times (frame numbers) acquired from the decoding sections 215 and 216.

The interpolation processing section 218 is an example of an image compositing unit of the present disclosure. The interpolation processing section 218 performs the interpolation process of the reproduction moving image v10 using the interpolation moving image v12. The interpolation processing section 218 takes, from the time control section 217, the frame time of a current frame of a frame image of the reproduction moving image v10 received from the decoding section 215 that decodes the reproduction moving image v10 and a frame image of the interpolation moving image v12 received from the decoding section 216 that decodes the interpolation moving image v12. In addition, the interpolation processing section 218 acquires coordinates of an interpolation region of the frame time from the interpolation information i10 received by the reception section 213, and combines the frame image of the interpolation moving image v12 in the position of the coordinates of the frame image of the reproduction moving image v10. Then, the interpolation processing section 218 outputs an interpolated frame image v13 obtained by making a high-quality partial region (an interpolation region) of a moving image screen of the reproduction moving image v10 with the interpolation moving image v12.

The interpolated frame image v13 may be reproduced on a screen of the reproduction device 200, stored in a transmission and recording unit 240 by being encoded into a moving image by an encoding unit 230, or transmitted to another device.

The interpolation unit 210 can execute the interpolation process in which a part of the reproduction moving image v10 is interpolated with the high-quality interpolation moving image v12 using the interpolation moving image v12 and the interpolation information i10 for interpolating the reproduction moving image v10 with the configuration shown in FIG. 4. The interpolation unit 210 can enhance a viewing experience of a user by executing the interpolation process in which a part of the reproduction moving image v10 is interpolated into the high-quality interpolation moving image v12.

Hereinabove, the functional configuration example of the interpolation unit 210 included in the reproduction device 200 according to the embodiment of the present disclosure has been described with reference to FIG. 4. Next, an operation example of the interpolation moving image generation unit 120 according to an embodiment of the present disclosure will be described.

### [Operation Example of the Interpolation Moving Image Generation Unit]

FIG. 5 is a flowchart showing the operation example of the interpolation moving image generation unit 120 according to the embodiment of the present disclosure. The flowchart shown in FIG. 5 is for the operation example of the interpolation moving image generation unit 120 according to the embodiment of the present disclosure when the interpolation moving image v12 and the interpolation information i10 are generated. Hereinafter, the operation example of the interpolation moving image generation unit 120 according to the embodiment of the present disclosure will be described with reference to FIG. 5.

First, the interpolation moving image generation unit 120 decodes the (encoded) high-quality moving image v11, thereby generating a decoded frame image (Step S101). The frame image is data in which a pixel group of one screen is arranged.

When the frame image of the high-quality moving image v11 is generated in Step S101, the interpolation instruction unit 121 of the interpolation moving image generation unit 120 then acquires information instructed as an interpolation region in the decoded frame image (Step S102). For example, a user can see the frame image and then instruct the coordinates, the width, and the height of the interpolation region. Here, the “user” may include a user who reproduces the reproduction moving image v10, a person from a distribution service provider that distributes the reproduction moving image v10 (for example, an editor who edits the reproduction moving image v10 or a sport commentator who gives commentary on a sport game if the reproduction moving image v10 is a sport moving image), or the like. In addition, information of the region instructed by the user beforehand or obtained by automatically extracting an interpolation region through a moving image recognition process may be stored in a file in the form of a line of a frame time (frame number), the coordinates, the width, and the height of the interpolation region. When an interpolation moving image is generated, information instructed as the interpolation region is read, and information of the interpolation region corresponding to the frame time (frame number) of each decoded frame is acquired.

For example, the moving image analysis unit 300 may automatically decide a region to interpolate by analyzing the high-quality moving image v11 using techniques of face recognition, moving body recognition, perspective recognition, and the like. In addition, designation of the user (a user who reproduces the reproduction moving image v10, a person from the distribution service provider that distributes the reproduction moving image v10, or the like) may be combined with analysis of the moving image by the moving image analysis unit 300. There is a moving image analysis technique of tracing motions of an object that a user instructs. Using the moving image analysis technique of tracing motions of an object, for example, when a user instructs a player in a moving image of a sport game, the moving image analysis unit 300 may trace motions of the instructed player and set a region obtained from the tracing as an interpolation region.

The interpolation instruction unit 121 delivers the information (the coordinates, the width, and the height) of the interpolation region generated based on an instruction of the user (a user who reproduces the reproduction moving image v10, a person from the distribution service provider that distributes the reproduction moving image v10, or the like) or a result of image recognition to the interpolation information processing unit 123. The interpolation information processing unit 123 transfers the information of the interpolation region transferred from the interpolation instruction unit 121 to the frame image extraction unit 124.

Next, the interpolation moving image generation unit 120 extracts the pixel group of the region (of the coordinates, the width, and the height) designated by the interpolation instruction unit 121 from the frame image of the decoded high-quality moving image v11 in the frame image extraction unit 124 (Step S103).

When the pixel group of the designated region (of the coordinates, the width, and the height) is extracted from the frame image of the high-quality moving image v11 in Step S103, the interpolation moving image generation unit 120 subsequently sets the extracted pixel group as the frame image of the interpolation region, causes the encoding unit 125 to encode the frame image, and then writes the frame image in a file, thereby generating the interpolation moving image v12 (Step S104).

An encoding rate during the encoding of Step S104 can be decided to be a lower rate than that of the original high-quality moving image v11. In general encoding of a moving image, if an image size (an area, or the number of pixels in a screen) is small, an encoding rate necessary for maintaining equivalent image quality may be low. For this reason, the encoding rate may be decided based on, for example, a ratio of the high-quality moving image v11 to the size (area) of the frame image of the interpolation region. If an area ratio is 10:1, for example, the encoding unit 125 may perform encoding at an encoding rate of 10% of that of the high-quality moving image v11. In addition, the encoding unit 125 can also decide the encoding rate using a characteristic of an S/N ratio of an encoding system.

In addition, the interpolation moving image generation unit 120 causes the interpolation information processing unit 123 to record the frame time (frame number) and the information of the coordinates, the width, and the height of the interpolation region on the frame image of the high-quality moving image v11 in the file, thereby recording the interpolation information i10 (Step S105).

By the interpolation moving image generation unit 120 repeating the series of operations shown in FIG. 5 to the final frame of the high-quality moving image v11, the interpolation moving image v12 obtained by extracting only the interpolation region from the high-quality moving image v11 and the interpolation information i10, in which the coordinates in each frame in which the interpolation moving image v12 should be disposed are recorded, are generated. On top of that, in the interpolation information i10, the overall image size of the high-quality moving image v11, the title and the identifier of the moving image content, and information on the interpolation name and interpolation identifier of the interpolation moving image can also be recorded. As described above, the high-quality moving image v11 and the reproduction moving image v10 are associated with each other as the same moving image content. Thus, by causing the title and the identifier of the high-quality moving image v11 that serves as the base of the interpolation moving image v12 to be included in the interpolation information i10, the generated interpolation moving image v12 can be associated with the reproduction moving image v10 which is to be interpolated. In addition, when a plurality of interpolation moving images v12 and pieces of interpolation information i10 are created for one piece of moving image content, a user can select an interpolation moving image by causing the interpolation names and the interpolation identifiers of the interpolation moving images v12 to be included in the interpolation information i10.

Hereinabove, the operation example of the interpolation moving image generation unit 120 according to the embodiment of the present disclosure has been described with reference to FIG. 5. Next, operation examples of the interpolation moving image transmission unit 130 according to an embodiment of the present disclosure will be described.

### [Operation Example of the Interpolation Moving Image Transmission Unit]

FIGS. 6 and 7 are flowcharts showing operation examples of the interpolation moving image transmission unit 130 according to the embodiment of the present disclosure. The flowcharts shown in FIGS. 6 and 7 are for the operation examples of the interpolation moving image transmission unit 130 according to the embodiment of the present disclosure performed when the interpolation moving images v12 and the interpolation information i10 are transmitted to the reproduction device 200. Hereinafter, the operation examples of the interpolation moving image transmission unit 130 according to the embodiment of the present disclosure will be described with reference to FIGS. 6 and 7.

First, one of the operation examples of the interpolation moving image transmission unit 130 performed when a list of the interpolation moving images v12 and the interpolation information i10 is transmitted to the reproduction device 200 will be described. The interpolation list management unit 133 of the interpolation moving image transmission unit 130 receives a request for the interpolation moving images v12 and the interpolation information i10 from the interpolation unit 210 of the reproduction device 200 (Step S111). The request received from the reproduction device 200 includes a content identifier for identifying moving image content.

When the request is received from the interpolation unit 210 in Step S111, the interpolation list management unit 133 designates the content identifier transmitted from the reproduction device 200 and acquires the retained list of the interpolation moving images v12 and the interpolation information i10 from the interpolation recording unit 132 (Step S112). The list of the interpolation moving images v12 and the interpolation information i10 can be included in a line of the interpolation name and the interpolation identifier.

When the list of the interpolation moving images v12 and the interpolation information i10 is acquired from the interpolation recording unit 132 in Step S112, the interpolation list management unit 133 returns the acquired list to the interpolation unit 210 of the reproduction device 200 (Step S113).

Next, the other operation example of the interpolation moving image transmission unit 130 performed when the interpolation moving images v12 and the interpolation information i10 are transmitted to the reproduction device 200 will be described. The interpolation unit 210 that has received the list of the interpolation moving images v12 and the interpolation information i10 decides which interpolation moving image v12 and interpolation information i10 should be acquired, designates the interpolation identifier, and then requests transmission of the interpolation moving image v12 and the interpolation information i10 to the interpolation moving image transmission unit 130. The interpolation list management unit 133 receives the request for the transmission of the interpolation moving image v12 and the interpolation information i10 transmitted from the interpolation unit 210 (Step S121).

When the request for the transmission is received in Step S121, the interpolation list management unit 133 designates the interpolation identifier that has been designated by the interpolation unit 210 in the transmission unit 134, and then instructs the transmission of the interpolation moving image v12 and the interpolation information i10 (Step S122).

When the interpolation list management unit 133 instructs the transmission of the interpolation moving image v12 and the interpolation information i10 in Step S122 described above, the transmission unit 134 designates the interpolation identifier for the interpolation recording unit 132 and acquires the file of the interpolation moving image v12 and the interpolation information i10, and then transmits the acquired file to the interpolation unit 210 (Step S123).

The interpolation moving image transmission unit 130 can transmit the interpolation moving image v12 generated from the high-quality moving image v11 and the interpolation information i10 for interpolating the reproduction moving image v10 using the interpolation moving image v12 to the reproduction device 200 by executing the operations shown in FIGS. 6 and 7.

Hereinabove, the operation examples of the interpolation moving image transmission unit 130 according to the embodiment of the present disclosure have been described with reference to FIGS. 6 and 7. Next, operation examples of the interpolation unit 210 that is included in the reproduction device 200 according to an embodiment of the present disclosure will be described.

### [Operation Example of the Interpolation Unit]

FIGS. 8 and 9 are flowcharts showing the operation examples of the interpolation unit 210 that is included in the reproduction device 200 according to the embodiment of the present disclosure. The flowcharts shown in FIGS. 8 and 9 are for the operation examples of the interpolation unit 210 according to the embodiment of the present disclosure performed when an interpolation process of the reproduction moving image v10 is executed using the interpolation moving image v12. Hereinafter, the operation examples of the interpolation unit 210 that is included in the reproduction device 200 according to the embodiment of the present disclosure will be described with reference to FIGS. 8 and 9.

When a user of the reproduction device 200 decides the reproduction moving image v10 to be reproduced in the reproduction device 200 (Step S131), the interpolation moving image selection section 214 decides the interpolation moving image v12 and the interpolation information i10 corresponding to the decided reproduction moving image v10 (Step S132). The interpolation moving image selection section 214 designates the content identifier of the reproduction moving image v10 for the interpolation moving image transmission unit 130 and acquires the list of the interpolation moving images v12 and the interpolation information i10 retained by the interpolation moving image transmission unit 130. The interpolation moving image selection section 214 decides an interpolation moving image v12 to be used in the interpolation process from the acquired list. For example, by displaying a list of interpolation names acquired by the interpolation moving image selection section 214 to allow the user to select one from the list, the interpolation moving image v12 to be used in the interpolation process is decided. The interpolation moving image selection section 214 requests transmission of the decided interpolation moving image v12 and interpolation information i10 to the interpolation moving image transmission unit 130.

When the interpolation moving image transmission unit 130 transmits the interpolation moving image v12 and the interpolation information i10 according to the request, the interpolation unit 210 executes the interpolation process of the reproduction moving image v10 transmitted from the reproduction moving image transmission unit 110 using the transmitted interpolation moving image v12 and the interpolation information i10 (Step S133). FIG. 9 is a flowchart showing details of the interpolation process of Step S133.

The reception section 211 that receives the reproduction moving image v10 delivers the received reproduction moving image v10 to the decoding section 215 and causes the decoding section 215 to decode the reproduction moving image v10. The reception section 212 that receives the interpolation moving image v12 delivers the received interpolation moving image v12 to the decoding section 216 and causes the decoding section 216 to decode the interpolation moving image v12. The reception section 213 that receives the interpolation information i10 delivers the received interpolation information i10 to the interpolation processing section 218.

The decoding section 215 that decodes the reproduction moving image v10 decodes one frame of the reproduction moving image v10, thereby generating a decoded frame image (Step S141). In addition, the decoding section 215 transfers the frame time (frame number) of the frame decoded this time to the time control section 217.

The decoding section 216 that decodes the interpolation moving image v12 decodes one frame of the interpolation moving image v12, thereby generating a decoded frame image (Step S144). In addition, the decoding section 216 transfers the frame time (frame number) of the frame decoded this time to the time control section 217.

The time control section 217 compares the frame times of the reproduction moving image v10 and the interpolation moving image v12 (Steps S142 and S145). If the frame times are identical as a result of comparing the frame times of the reproduction moving image v10 and the interpolation moving image v12, the time control section 217 transfers the frame times to the interpolation processing section 218. On the other hand, when the frame times are not identical as a result of comparing the frame times of the reproduction moving image v10 and the interpolation moving image v12, the time control section 217 causes decoding of the frames to be repeated until the frame times become identical. For example, the time control section 217 discards the frame image of the moving image having an earlier frame time (having a lower frame number) with reference to a later frame time (a higher frame number). Then, the time control section 217 instructs the decoding sections 215 and 216 to perform the next frame decoding, and repeats the comparison process until a decoded frame image having the same time as the reference frame time (the later frame time) is output.

If the frame times of the reproduction moving image v10 and the interpolation moving image v12 are identical, the interpolation processing section 218 enlarges or reduces the decoded frame image of the reproduction moving image v10 and the interpolation moving image v12 so that the decoded frame images fir to a standard image size to be described later (Steps S143 and S146). The interpolation processing section 218 decides a magnification of each decoded frame image so that the size of the decoded frame image of the reproduction moving image v10 and the size of the high-quality moving image v11 that serves as the base of the interpolation moving image v12 become the same as the standard image size. The interpolation processing section 218 can acquire the size of the high-quality moving image v11 that serves as the base of the interpolation moving image v12 from the interpolation information i10.

FIG. 11 is a descriptive diagram showing the enlargement and reduction processes in Steps S143 and S146. As shown in FIG. 11, the interpolation processing section 218 enlarges or reduces the decoded frame images of the reproduction moving image v10 and the interpolation moving image v12 so that the decoded frame images fit to the standard image size.

It is assumed that, for example, the standard image size is a display screen size of a moving image and the relationship of a reproduction moving image screen<a display screen<an original high-quality moving image screen in terms of image sizes is valid. In this case, with regard to the width and height of each screen size, the width BW×the height BH is set for the standard image size (here, the size of the display screen of a moving image), the width PW×the height PH is set for the reproduction moving image screen size, and the width HW×the height HH is set for the original high-quality moving image screen size. As an example, it assumed that the width PW of the reproduction moving image screen is 640 pixels and the height PH thereof is 360 pixels, the width BW of the standard image size is 1280 pixels and the height BH thereof is 720 pixels, and the width HW of the original high-quality moving image screen size is 1920 pixels and the height HH thereof is 1080 pixels. In addition, the width MW×the height MH is set for an interpolation moving image screen size.

In such a case, the interpolation processing section 218 enlarges the frame image of the reproduction moving image v10 to the display screen size. In the example described above, since the number of pixels in the widths and the heights differ by a factor of two (BW=PW×2, and BH=PH×2), the interpolation processing section 218 enlarges the frame image of the reproduction moving image v10 to a display screen size by vertically and horizontally arranging each pixel of the frame image of the reproduction moving image v10 on two spots.

On the other hand, the interpolation processing section 218 reduces the frame image of the interpolation moving image v12. The magnification of the reduction is set by the ratio between the image size of the high-quality moving image v11 that serves as the base of the interpolation moving image v12 and the display screen size. In the example described above, the ratio between the numbers of vertical and horizontal pixels is the high-quality moving image screen size:the standard image size=3:2 (in other words, BW=HW×⅔, and BH=HH×⅔). Thus, the interpolation processing section 218 reduces the frame image of the interpolation moving image v12 by thinning out the numbers of vertical and horizontal pixels to be ⅔. For example, when the width MW of the frame image of the interpolation moving image v12 is 192 pixels and the height MH thereof is 108 pixels, the interpolation processing section 218 respectively reduces the width of the frame image of the interpolation moving image v12 to be 128 pixels and the height thereof to be 72 pixels.

By enlarging or reducing the frame images as described above, the interpolation processing section 218 can process the frame image of the reproduction moving image v10 and the frame image of the interpolation moving image v12 as pixel rows on the same coordinate axes of the standard image size (an area in an image size of BW×BH).

Next, the interpolation processing section 218 acquires, from the interpolation information i10, the information of the coordinates, the width, and the height of the interpolation region corresponding to the frame time given from the time control section 217. As described above, the interpolation coordinates are described for each frame time in the interpolation information, but the coordinates, the width, and the height are values in terms of the image size of the original high-quality moving image v11. Thus, the interpolation processing section 218 changes the values of the interpolation coordinates of each frame time to be the coordinates, the width, and the height of the standard image size in the same manner as in Steps S143 and S146 (Step S147). As described above, for example, when the ratio of the numbers of vertical and horizontal pixels of the image size of the high-quality moving image v11 and the standard image size is 3:2, if the coordinates [x, y] of the interpolation region in the high-quality moving image v11 is [90, 60], the interpolation processing section 218 sets the coordinates of the interpolation region on the standard image size to be [60, 40] that is obtained by multiplying the coordinate values of the interpolation region by ⅔.

Next, the interpolation processing section 218 performs overlay drawing (overwriting of pixels) of the frame image of the interpolation moving image v12 on the frame image of the reproduction moving image v10 (Step S148). The coordinates of the frame image of the interpolation moving image v12 overlay-drawn on the frame image of the reproduction moving image v10 are set to coordinates obtained by converting the coordinates of a corresponding frame time of the interpolation information i10 into the coordinates on the standard image size. Since magnification change and coordinate conversion are performed so that all of the frame image of the reproduction moving image v10, the frame image of the interpolation moving image v12, and the interpolation coordinates become images (pixel groups) and pixel coordinates on the same standard image size, the interpolation processing section 218 can deal with the frame image of the reproduction moving image v10, the frame image of the interpolation moving image v12, and the interpolation coordinates described above as pixel groups and a coordinate position on the same coordinates.

The interpolation unit 210 can execute the interpolation process of interpolating a part of the reproduction moving image v10 with the interpolation moving image v12 by executing the processes shown in FIGS. 8 and 9 using the interpolation information i10 for interpolating the interpolation moving image v12 and the reproduction moving image v10. The interpolation unit 210 can enhance a viewing experience of a user by executing the interpolation process of interpolating the part of the reproduction moving image v10 with the high-quality interpolation moving image v12.

### CONCLUSION

In the moving image reproduction system 1 according to the embodiment of the present disclosure as described above, a partial region (for example, in the case of a sports broadcast, a region of an appearance of a player, a score display, or the like of which recognition should be improved in a moving image of the broadcast, or a region thereof that is considered to be important in the moving image) of a display screen in which the reproduction moving image v10 of low quality is interpolated with the interpolation moving image v12 of high quality. By interpolating the reproduction moving image v10 of low quality with the interpolation moving image v12 of high quality, the moving image reproduction system 1 according to the embodiment of the present disclosure can enhance a viewing experience of a user.

As the moving image reproduction system 1 according to the embodiment of the present disclosure only transmits the interpolation moving image v12 that includes an interpolation region portion extracted from the high-quality moving image v11 rather than the entire original high-quality moving image v11, the moving image reproduction system can reduce the amount of information of the interpolation moving image v12 and lower the encoding rate (transmission rate). In addition, since the reproduction device 200 may be configured to perform arithmetic operations on coordinates and combine images without being configured to have an arithmetic operation load and a dedicated arithmetic operation circuit that perform up-conversion on the reproduction moving image v10, even if a processing capability of the reproduction device 200 is not great in the moving image reproduction system 1 according to the embodiment of the present disclosure, the reproduction moving image v10 can be interpolated in the reproduction device 200 without placing an excessive load on the reproduction device 200.

In the example described above, the interpolation moving image v12 and the interpolation information i10 are generated in advance and stored as a file in the interpolation moving image generation unit 120. The present disclosure is not limited to the example. The interpolation moving image v12 and the interpolation information i10 may be set to be dynamically generated.

The reproduction unit 220 of the reproduction device 200 may be provided with, for example, the interpolation instruction unit 121 included in the interpolation moving image generation unit 120. A case in which a user instructs an interpolation region to the reproduction moving image v10 while viewing the reproduction moving mage v10 being reproduced will be exemplified. The interpolation instruction unit 121 transmits the coordinates, the width, and the height of the interpolation region and the image size of the reproduction screen of the reproduction moving image v10 reproduced in the reproduction unit 220 to the interpolation moving image generation unit 120. With regard to the coordinates, the width, and the height of the interpolation region received from the reproduction device 200, the interpolation moving image generation unit 120 performs coordinate conversion of the size of the reproduction screen that is also received from the reproduction device 200 into the size of a screen of the high-quality moving image v11 corresponding to the reproduction moving image v10. This process is inverse conversion of the coordinate conversion of Steps S143 and S146 described above. Then, the interpolation moving image generation unit 120 extracts a region (or a region after the conversion) designated from the high-quality moving image v11, thereby generating the interpolation moving image v12, and transmits the interpolation moving image to the interpolation unit 210 via the interpolation moving image transmission unit 130.

In addition, for example, a case in which a distributor instructs an interpolation region in real time in real-time distribution using a live camera, or the like will be exemplified. In this case, a real-time moving image (generated by the live camera, or the like) corresponds to the high-quality moving image v11 (an original moving image) described above. While the distributor of the moving image transmits the reproduction moving image v10 in a small image size at a low encoding rate for distribution, the distributor instructs a region to which viewers are desired to pay attention as an interpolation region to the interpolation moving image generation unit 120 with regard to a moving image frame generated from a live camera moving image in real time. Every time the interpolation moving image generation unit 120 receives the moving image frame from the live camera, the interpolation moving image generation unit extracts the frame image from the instructed region and sets the frame image as a frame image of the interpolation moving image v12, and then transmits the frame image and interpolation information i10 thereof to the interpolation moving image transmission unit 130. The interpolation moving image transmission unit 130 transmits the frame of the interpolation moving image v12 and the interpolation information i10 to the interpolation unit 210 in real time.

In order to reduce delay of the interpolation unit 210 in receiving the interpolation moving image v12 corresponding to the reproduction screen, transmission timings of the reproduction moving image v10 and the interpolation moving image v12 can be matched by causing the reproduction moving image transmission unit 110 and the interpolation moving image transmission unit 130 to interwork so as to match transmission times of the moving images or by installing the reproduction moving image transmission unit 110 and the interpolation moving image transmission unit 130 in a same device. Furthermore, in the example of the real-time distribution such as a live camera, or the like, generation and transmission of a frame of an interpolation moving image can be combined by integrating the interpolation moving image generation unit 120 that receives the moving image from the live camera with the reproduction moving image transmission unit 110, or integrating the interpolation moving image generation unit 120 with the interpolation moving image transmission unit 130.

In addition, when the interpolation moving image selection section 214 of the interpolation unit 210 decides an interpolation moving image, a user is instructed to select an interpolation moving image from an interpolation list in the example described above, however, the present disclosure is not limited to the example. For example, using an interpolation target that is highly popular on the network, preference analysis of viewers, a past selection trend of interpolation targets, or the like, the interpolation moving image selection section 214 may automatically select an interpolation target, or propose a recommendable interpolation target. For example, the interpolation moving image selection section 214 may automatically select the player A who was selected by viewers many times as an interpolation target, or propose the player A as a recommendable interpolation target.

For the high-quality moving image v11 that is the extraction source of the interpolation moving image v12, for example, an original (original clip of a) high-quality moving image that the moving image distributor retains can be used as described above. On the other hand, there is a case in which there is no such original clip of a high-quality moving image. For example, a moving image such as private content produced by an individual, or a moving image produced in the past does not have an original clip of a high-quality moving image. In this case, a moving image that does not have an original clip of a high-quality moving image may be transmitted to and stored in the interpolation moving image generation unit 120. In addition, using the high image quality operation and up-conversion technique of a single moving image disclosed in, for example, JP 2010-11448A described above, the interpolation moving image generation unit 120 may be caused to generate a quasi-high-quality moving image v11, and the high-quality moving image v11 may be set as an extraction source of the interpolation moving image v12.

In this case, high-load arithmetic operation or a special circuit for the high image quality process may be assigned to the interpolation moving image generation unit 120 rather than the reproduction device 200. Thus, even when there is no original clip of a high-quality moving image, a load on the reproduction device 200 or cost can be reduced, and if the high-load arithmetic operation or the special circuit for the high image quality process is assigned to the interpolation moving image generation unit 120, an expensive high image quality circuit having high performance can be disposed in the interpolation moving image generation unit 120. In addition, since only the interpolation moving image generation unit 120 may perform an arithmetic operation for high image quality and the generated quasi-high-quality moving image v11 is stored in the interpolation moving image generation unit 120, the arithmetic operation for high image quality may be performed only once.

It should be noted that, with regard to network transmission of a moving image, a technology of automatically adjusting an encoding rate of a moving image that is transmitted at a transmission rate of a transmission path in MPEG-DASH (Dynamic Adaptive Streaming over HTTP; published as ISO/IEC 23009-1) is disclosed. The technology of MPEG-DASH can be applied to the present disclosure.

For example, the interpolation moving image v12 may be encoded at a plurality of encoding rates and arranged as a file group by being divided into segments, and the technology of MPEG-DASH may be used in transmission of the interpolation moving image v12. In addition, when the transmission rates of both of the reproduction moving image v10 and the interpolation moving image v12 are adjusted using MPEG-DASH, the upper limits and lower limits of both transmission rates may be set to adjust the transmission rates of both moving images.

For example, a case in which transmission of a moving image is started with a transmission band of 5 Mbps, the transmission rate of the reproduction moving image v10 (transmitted from the reproduction moving image transmission unit 110) is 4 Mbps, and a transmission band of the interpolation moving image v12 is the remaining 1 Mbps is considered. In this case, the ratio of the transmission rate of the reproduction moving image v10 to the transmission rate of the interpolation moving image v12 is assumed to be 4:1. In MPEG-DASH, an actual rate during transmission of a moving image is measured and the transmission rate of the moving image is adjusted in accordance with the actual rate. In this case, the reproduction device 200 finds the sum of actual transmission rates by totaling the actual transmission rates of both moving images, ⅘ of the sum of the actual transmission rates is set to be the upper limit of the transmission rate of the reproduction moving image v10, and ⅕ of the sum of the actual transmission rates is set to be the upper limit of the transmission rate of the interpolation moving image v12, and thereby the transmission rates of both moving images may be adjusted.

In addition, description that will be provided hereinbelow includes a scheme of changing the size of an interpolation region transmitted as the interpolation moving image v12. For example, there is a case in which, although the overall size of an interpolation moving image screen does not change, the pixel amount of the interpolation region embedded in the screen increases, or the number of interpolation moving image groups (divided screen moving image groups) to be transmitted increases due to the area of the interpolation region. In other words, due to the size of the interpolation region, the information amount of the interpolation moving image v12 to be transmitted increases.

In the case of the scheme, when the reproduction device 200 apportions ratios of the reproduction moving image v10 and the interpolation moving image v12, the reproduction device may lower the ratio of the interpolation moving image v12 during a period in which the interpolation region has a small size and may raise the ratio during a period in which the interpolation region has a large size.

In addition, the interpolation unit 210 that is provided on the moving image reception side in charge of deciding a moving image transmission rate (in other words, selecting a moving image file to be acquired) in MPEG-DASH acquires the interpolation information i10. Since the interpolation unit 210 can know the size of an interpolation region in advance at a future moving image time when using the interpolation information i10, the apportionment of the ratio of the interpolation moving image v12 based on the size of the interpolation region may be performed in advance.

### 2. EXAMPLE 1

### Overview

In the embodiment of the present disclosure described above, the image of an interpolation region is set to be a moving image screen as is. In this case, the image size of the interpolation region is of course considered to be changed for each frame of the interpolation moving image v12. In other words, the size of the interpolation region of the reproduction moving image v10 to be interpolated in a reproduction screen is considered to be frequently changed. When a region of a moving image screen in which a specific player is displayed in sport content is interpolated, for example, the interpolation region becomes small or large as the player moves.

On the other hand, most moving image encoding schemes and decoding processes do not deal with moving images of which the size (the size of a moving image screen) is not changed for each frame. Thus, an example that supposes a case in which the size of an interpolation region is changed for each frame in order to realize the interpolation moving image v12 in which only the interpolation region is set to be a moving image screen will be described.

FIG. 17 is a descriptive diagram showing an example of changes of the image size of an interpolation region and a moving image screen of the interpolation moving image v12 according to Example 1. In Example 1, the width and the height of the moving image screen of the interpolation moving image v12 are assumed to be the maximum width (MW) and the maximum height (MH) of a moving image screen among an interpolation region group of all frames as shown in FIG. 17.

As shown in FIG. 17, for example, when the size of the interpolation region of Frame 0 of the high-quality moving image v11 is 50×100, the size of the interpolation region of Frame 1 is 70×150, and the size of the interpolation region of Frame 2 is 100×80, the width 100 of the interpolation region of Frame 2 is the maximum width (MW), and the height 150 of the interpolation region of Frame 1 is the maximum height (MH). Thus, in the present example, for the image size of the moving image screen of the interpolation moving image v12, the width MW is fixed to 100 and the height MH is fixed to 150. The image sizes of the interpolation regions of the frames are limited to 100×150.

Even if the sizes of the interpolation regions of the frames are changed by setting the region having the maximum width (MW) and the maximum height (MH) of the interpolation region group of all frames to be an interpolation region, the image size of the moving image screen of the interpolation moving image v12 is fixed to 100×150 at all times, and can be processed in the existing moving image encoding scheme and decoding process. In addition, by setting the region having the maximum width (MW) and the maximum height (MH) of the interpolation region group of all frames to be an interpolation region, the interpolation moving image v12 of a minimum region that can include all interpolation region groups is generated in the present example.

By fixing the image size of the moving image screen of the interpolation moving image v12 as described above, the image size of the interpolation region of each frame is different from that of the moving image screen of the interpolation moving image v12. Thus, in the present example, the image size of the interpolation region of each frame is managed separately from that of the moving image screen of the interpolation moving image v12. In order to manage the image size of the interpolation region of each frame separately from that of the moving image screen of the interpolation moving image v12, both sizes are written in the interpolation information i10 in the present example.

For example, the interpolation moving image generation unit 120 describes the size (MW×MH) of the moving image screen of the interpolation moving image v12 in the head of the interpolation information i10, and describes the size of the interpolation region of each frame in the interpolation information i10. Since the size of the moving image screen of the interpolation moving image v12 is fixed over all frames and is not changed, it is not necessary to describe the size for each frame. Since the position and the size of the interpolation region can be changed in each frame, the size thereof is described for each frame. When the interpolation unit 210 decodes the interpolation moving image v12, the decoding section 216 generally returns the size of a decoded frame image as information, and thus the size of the moving image screen of the interpolation moving image v12 can also be acquired from the decoded frame image. In this case, only the size of the interpolation region may be described in the interpolation information i10.

Next, the moving image screen of the interpolation moving image v12 and the coordinates of the interpolation region will be described. FIG. 18 is a descriptive diagram showing the relationship between the moving image screen of the interpolation moving image v12 and the coordinates of the interpolated region. It should be noted that the coordinates refer to the coordinates of the upper left corner of the interpolation region of the moving image screen of the interpolation moving image v12 on the moving image screen of the high-quality moving image v11.

The image size of the high-quality moving image v11 is assumed to be the width HW×the height HH and the image size of the interpolation moving image v12 is assumed to be the width MW×the height MH. In addition, the upper-left coordinates of the interpolation region of each frame are assumed to be [x, y] and the image size of the interpolation region is assumed to be the width DW×the height DH.

As shown in FIG. 18, the interpolation region is assumed to be positioned in a lower right portion of the moving image screen of the high-quality moving image v11. For example, HW is assumed to be 1920 and HH is assumed to be 1080 with regard to the size of the moving image screen of the high-quality moving image v11, the coordinates [x, y] of the interpolation region are assumed to be [1850, 1000], and DW is assumed to be 50 and DH is assumed to be 70 with the size of the interpolation region. In this case, the lower-right coordinates [x+DW, y+DH] of the interpolation region are [1900, 1070], which are included in the moving image screen of the high-quality moving image v11.

The size of the interpolation moving image screen is different from that of the interpolation region, however, if the coordinates [x, y] of the moving image screen of the interpolation moving image v12 are set to [1850, 1000] as shown in FIG. 18, there is a case in which the interpolation region runs over the moving image screen of the high-quality moving image v11. If the image size of the moving image screen of the interpolation moving image v12 is 100×150 in the example as described above, and the image of 100×150 is extracted from the coordinates [1850, 1000], the lower-right coordinates [x+MW, y+MH] are [1950, 1150], and accordingly the image runs over the image size of the high-quality moving image v11 (HW=1920, HH=1080).

As a measure taken in the above case, for example, the interpolation unit 210 deviates the coordinates of the image to be extracted as the moving image screen of the interpolation moving image v12 to the upper-left side and then extracts the image so that the image does not run over the moving image screen of the high-quality moving image v11. Here, the coordinates of the image to be extracted on the upper left side are assumed to be the extraction coordinates [xx, yy]. For example, the interpolation unit 210 sets the extraction coordinates [xx, yy] to be [HW-MW, HH-MH]=[1820, 930] so that the lower-right corner of the moving image screen of the interpolation moving image v12 fits the lower-right boundary of the moving image screen of the high-quality moving image v11, and then sets the coordinates as the coordinates of the moving image screen of the interpolation moving image v12 of the frame. In this case, since the coordinates [xx, yy] of the moving image screen of the interpolation moving image v12 are different from the coordinates [x, y] of the interpolation region, it is desirable for both sets of coordinates to be separately managed. Thus, in the interpolation information i10, the coordinates [xx, yy] of the moving image screen of the interpolation moving image v12 that include the interpolation region (the coordinates set when the pixel group is extracted from the frame image of the high-quality moving image v11) are also described for each frame, in addition to the coordinates [x, y] of the interpolation region.

In the example of FIG. 18, the coordinates [x, y] of the interpolation region and the coordinates [xx, yy] of the moving image screen of the interpolation moving image v12 that include the interpolation region are marked on the coordinate axis of the moving image screen of the high-quality moving image v11, however, the present disclosure is not limited to the example. As another method, the coordinates of the moving image screen of the interpolation moving image v12 may be described as the coordinates on the moving image screen of the high-quality moving image v11 ([1820, 930]) and the coordinates of the interpolation region may be described as the coordinates within the moving image screen of the interpolation moving image v12 ([30, 70]).

As described above, in the present example, by setting the image size of the moving image screen of the interpolation moving image v12 to have the maximum width MW×the maximum height MH that can include the entire interpolation region, the image size of the moving image screen of the interpolation moving image v12 can be fixed and interpolation regions of all frames can be included therein. As a result, since the image size of the interpolation region is different from the image size of the moving image screen of the interpolation moving image v12, in the present example, both sizes are described in the interpolation information i10 so that the two sizes can be managed, or the image size of the moving image screen of the interpolation moving image v12 is acquired during decoding in the interpolation unit 210.

In addition, as the size of the moving image screen of the interpolation moving image v12 is different from the size of the interpolation region, the case in which the moving image screen of the interpolation moving image v12 runs over the moving image screen of the high-quality moving image v11 occurs as shown in FIG. 18, and thus the present example is designed not to cause the moving image screen of the interpolation moving image v12 to run over the moving image screen of the high-quality moving image v11 by adjusting the coordinates of the moving image screen of the interpolation moving image v12. As a result, since the coordinates of the interpolation region are different from the coordinates of the moving image screen of the interpolation moving image v12, both coordinates are described in the interpolation information i10 to manage both coordinates in the present example.

The interpolation unit 210 extracts the image of the interpolation region from the moving image screen of the interpolation moving image v12 based on the coordinates and size information of the interpolation region and the moving image screen of the interpolation moving image v12 described in the interpolation information i10. FIG. 19 is a descriptive diagram showing a process performed when the interpolation unit 210 extracts the image of the interpolation region from the moving image screen of the interpolation moving image v12.

First, the interpolation unit 210 decides the coordinates of the image of the interpolation region to be extracted from the moving image screen of the interpolation moving image v12 based on the difference between the coordinates of the image screen of the interpolation moving image v12 and the coordinates of the interpolation region. In the example shown in FIG. 19, the interpolation unit 210 understands that the moving image screen of the interpolation moving image v12 is an image extracted from the coordinates [1820, 930] on the moving image screen of the high-quality moving image v11, and the interpolation region is on the coordinates [1850, 1000] on the moving image screen of the high-quality moving image v11 based on information of Frame 3 of the interpolation information i10. Thus, the interpolation unit 210 determines that the coordinates [30, 70] within the frame image that is obtained by decoding Frame 3 of the interpolation moving image are the coordinates of the interpolation region. Then, the interpolation unit 210 extracts an image of the size (50×70) of the interpolation region by setting the coordinates [30, 70] as the upper-left coordinates. Finally, the interpolation unit 210 converts the coordinates and the size of the interpolation region from the coordinates and the size on the moving image screen of the high-quality moving image v11 into the coordinates and the size of the standard image, and then performs a combining process of the interpolation moving image v12 with the reproduction moving image v10.

### [Functional Configuration Example of the Interpolation Unit]

Next, a functional configuration example of the interpolation unit 210 for executing Example 1 will be described. FIG. 12 is a descriptive diagram showing the functional configuration example of the interpolation unit 210 according to Example 1 of an embodiment of the present disclosure. Particularly, FIG. 12 is a descriptive diagram showing a functional configuration example of the interpolation processing section 218 that is included in the interpolation unit 210.

As shown in FIG. 12, the interpolation processing section 218 according to Example 1 of the embodiment of the present disclosure is configured to include image magnification change parts 301 and 304, an interpolation coordinate calculation part 302, an interpolation region extraction part 303, and a frame image combination part 305.

The image magnification change parts 301 and 304 change magnification by enlarging or reducing the frame image (pixel group) that the decoding sections 215 and 216 decode. As described in the embodiment of the present disclosure above, the image magnification change parts 301 and 304 change magnification of the frame image of the reproduction moving image v10 and the frame image of the interpolation moving image v12 to the standard image size.

The interpolation coordinate calculation part 302 converts the values of the coordinates and the image size (the width and the height) of the interpolation region in the interpolation moving image v12 on the moving image screen of the original high-quality moving image v11 into the standard image size or decides an interpolation region to be extracted from the moving image screen of the interpolation moving image v12 based on the interpolation information i10 acquired by the interpolation processing section 218.

The interpolation region extraction part 303 extracts the image of the interpolation region from the decoded frame image obtained by decoding the interpolation moving image. The frame image combination part 305 combines the frame image of the reproduction moving image v10 with the image of the interpolation region extracted by the interpolation region extraction part 303 based on the interpolation coordinates after the magnification change calculated by the interpolation coordinate calculation part 302.

Hereinabove, the functional configuration example of the interpolation processing section 218 according to Example 1 has been described. Next, an operation example of the interpolation moving image generation unit 120 according to Example 1 will be described.

### [Operation Example of the Interpolation Moving Image Generation Unit]

FIGS. 13 to 15 are flowcharts showing the operation example of the interpolation moving image generation unit 120 according to Example 1. It should be noted that the configuration of the interpolation moving image generation unit 120 according to Example 1 is the same as that shown in FIG. 2. Hereinafter, the operation example of the interpolation moving image generation unit 120 according to Example 1 will be described with reference to FIGS. 13 to 15.

The interpolation instruction unit 121 receives an input of interpolation instructions (Step S201). The interpolation instruction unit 121 acquires information of the interpolation instructions for individual frames of the high-quality moving image v11, and retains the interpolation instructions of all frames in the form of a file, a database, a memory, or the like. The information of the interpolation instructions includes frame times, and the (upper-left) coordinates and the size (the width and the height) of interpolation regions.

When the interpolation instruction unit 121 receives the input of the interpolation instructions, the interpolation information processing unit 123 decides the size of the moving image screen of the interpolation moving image v12 (the width MW and the height MH) from the information input to the interpolation instruction unit 121 (Step S202).

The flowchart in FIG. 14 shows an operation of the interpolation information processing unit 123 in Step S202 of FIG. 13 in detail. First, the interpolation information processing unit 123 initializes the entire size (the width MW and the height MH) of the moving image screen of the interpolation moving image v12 to 0 (Step S211).

The interpolation information processing unit 123 then obtains the maximum width and height of an interpolation region group. The maximum width and height of the interpolation region group are obtained as shown in FIG. 17. When the maximum width and height of the interpolation region group are obtained, the interpolation information processing unit 123 acquires an interpolation-instructed region of one frame from the interpolation instruction unit 121 (Step S212). The width of the interpolation-instructed region is set to be DW and the height thereof is set to be DH. Next, the interpolation information processing unit 123 compares the value of DW to that of MW and the value of DH to that of MH, and sets the greater ones to be MW and MH, respectively (Step S213). In other words, if MW<DW, MW is updated to DW, and if MH<DH, MH is updated to DH. The interpolation information processing unit 123 repeats the processes of Steps S212 and 213 to the final frame of the high-quality moving image v11.

MW and MH finally obtained after the processes of Steps S212 and 213 are repeated to the final frame are the maximum width and height in the interpolation region group of all frames. The interpolation information processing unit 123 sets MW and MH as the size of the moving image screen of the interpolation moving image v12 and records the size in the interpolation information i10 (Step S214).

Description will be provided returning to FIG. 13. When the size of the moving image screen of the interpolation moving image v12 is decided in Step S202, the frame image extraction unit 124 then extracts an interpolation image from each frame image of the high-quality moving image v11 according to the size of the moving image screen of the interpolation moving image v12 (Step S203).

The flowchart shown in FIG. 15 shows the process of Step S203 of FIG. 13 in detail. The decoding unit 122 decodes one frame of the high-quality moving image v11, and delivers the decoded frame image to the frame image extraction unit 124. In addition, the decoding unit delivers the time (frame number) of the decoded frame and the image size (the width HW and the height HH) of the frame to the interpolation information processing unit 123 (Step S221).

The interpolation information processing unit 123 acquires interpolation region instruction information corresponding to the time of the decoded frame from the interpolation instruction unit 121 (Step S222). Here, the upper-left coordinates (on the moving image screen of the high-quality moving image v11) of the instructed interpolation region are set to be [x, y], the width is set to be DW and the height is set to be DH.

Next, the interpolation information processing unit 123 decides the coordinates [xx, yy] of the image to be extracted from the frame image of the high-quality moving image v11 as the moving image screen of the interpolation moving image v12 (Step S223). The coordinates [xx, yy] of the image to be extracted are decided as shown in FIG. 18. When the size MW×MH of the moving image screen of the interpolation moving image v12 is extracted from the interpolation region instruction coordinates [x, y], the lower-right coordinates of the moving image screen of the interpolation moving image v12 are [x+MW, y+MH]. The interpolation information processing unit 123 compares the lower-right coordinates of the moving image screen of the interpolation moving image v12 to the size HW×HH of the moving image screen of the high-quality moving image v11. When the coordinate of the right end [x+MW] of the extracted region is within HW, xx=x, and when the coordinate exceeds HW, xx=HW−MW. In addition, when the coordinate of the right end [y+MH] of the extracted region is within HH, yy=y, and when the coordinate exceeds HH, yy=HH−MH.

Next, the frame image extraction unit 124 acquires the coordinates [xx, yy] decided in Step S223 and the size MW×MH of the moving image screen of the interpolation moving image v12, and then extracts a pixel group of a region from the frame image of the high-quality moving image v11 decided based on the coordinates and the size of the moving image screen (Step S224).

Then, the encoding unit 125 encodes the pixel group extracted by the frame image extraction unit 124 in Step S224 as a moving image, thereby generating the interpolation moving image v12 (Step S225). Details of the encoding for generating the interpolation moving image v12 will be omitted since this is covered in Step S104 of FIG. 5 as described above.

In addition, as interpolation information of the frame, the interpolation information processing unit 123 records the frame time (frame number), the coordinates [x, y] instructed as the interpolation region, the size DW×DH of the interpolation region, and the coordinates (the coordinates [xx, yy] of the moving image screen of the interpolation moving image v12) from which the frame image extraction unit 124 extracts the image in the interpolation information i10 (Step S225).

The processes of Steps S221 to S225 are repeated to the final frame of the high-quality moving image v11.

By executing the operation as shown in FIGS. 13 to 15, the interpolation moving image generation unit 120 decides the size of the moving image screen of the interpolation moving image v12 that can include the entire interpolation region group of which size changes, and generates the interpolation moving image v12 of the size of the moving image screen from the high-quality moving image v11 by recording information of the size in the interpolation information i10. Then, the interpolation moving image generation unit 120 adjusts the coordinates of the image (the coordinates of the moving image screen of the interpolation moving image v12) to be extracted for each frame so that the image does not run over the moving image screen of the high-quality moving image v11, and records the original interpolation coordinates and the size and the coordinates of the extracted image of the moving image screen of the interpolation moving image v12 as the interpolation information. The interpolation moving image v12 generated by the interpolation moving image generation unit 120 and the interpolation information i10 are transmitted to the interpolation moving image transmission unit 130 via a transmission path such as a network.

Hereinabove, the operation example of the interpolation moving image generation unit 120 according to Example 1 has been described. Since an operation of the interpolation moving image transmission unit 130 according to Example 1 is the same as the operation example shown in FIGS. 6 and 7, detailed description thereof is omitted herein. Next, an operation example of the interpolation processing section 218 that is included in the interpolation unit 210 according to Example 1 will be described.

### [Operation Example of the Interpolation Processing Section]

FIG. 16 is a flowchart showing the operation example of the interpolation processing section 218 included in the interpolation unit 210 according to Example 1. Hereinafter, the operation example of the interpolation processing section 218 included in the interpolation unit 210 according to Example 1 will be described with reference to FIG. 16.

FIG. 16 shows details of the interpolation process of Step S133 of FIG. 8. The decoding section 215 that decodes the reproduction moving image v10 decodes one frame of the reproduction moving image v10, thereby generating a decoded frame image (Step S231). In addition, the decoding section 215 transfers the frame time (frame number) of the frame decoded this time to the time control section 217.

The decoding section 216 that decodes the interpolation moving image v12 decodes one frame of the interpolation moving image v12, thereby generating a decoded frame image (Step S233). In addition, the decoding section 216 transfers the frame time (frame number) of the frame decoded this time to the time control section 217.

The time control section 217 matches the times so that the frame time of the reproduction moving image v10 is synchronized with the frame time of the interpolation moving image v12 (Steps S231 and S233).

When the frame time of the reproduction moving image v10 is synchronized with the frame time of the interpolation moving image v12 by the time control section 217, the interpolation region extraction part 303 then extracts an image of an interpolation region from the frame image of the interpolation moving image v12 (Step S234). The extraction of the image of the interpolation region is performed as shown in FIG. 19.

The interpolation region extraction part 303 acquires the coordinates [xx, yy] of the interpolation moving image v12 from interpolation information of a target frame time. The coordinates are those obtained when the interpolation moving image generation unit 120 extracts pixels from the frame image of the high-quality moving image v11 and those of the interpolation moving image v12. For example, the coordinates are assumed to be [xx:1820, yy:930].

In addition, the interpolation region extraction part 303 acquires the coordinates [x, y] of the interpolation region from the interpolation information of the target frame time. The coordinates are those of the region for which interpolation is instructed in the interpolation moving image generation unit 120. For example, the coordinates are [x:1850, y:1000].

The coordinates of the interpolation region of the interpolation moving image v12 to be extracted are [x-xx, y-yy] when the upper left side of the moving image screen of the interpolation moving image v12 is set as a base point, and the coordinates are obtained in view of the example described above, [x-xx, y-yy]=[30, 70].

Then, the interpolation region extraction part 303 acquires the size (the width DW and the height DH) of the interpolation region from the interpolation information of the target frame time. For example, DW=50 and DH=70.

The interpolation region extraction part 303 finally extracts a pixel group in the size (DW=50 and DH=70) of the interpolation region from the upper-left coordinates ([30, 70] in the example described above) of the interpolation moving image v12.

When the interpolation region extraction part 303 extracts the image of the interpolation region, the image magnification change parts 301 and 304 enlarge or reduce the decoded frame images of the reproduction moving image v10 and the interpolation moving image v12 so as to fit to the standard image size (Steps S232 and S235). Since the processes performed in Steps S232 and S235 are the same as those of Steps S143 and S146 of FIG. 9, detailed description thereof is omitted.

When the image magnification change parts 301 and 304 enlarge or reduce the decoded frame images of the reproduction moving image v10 and the interpolation moving image v12, the image magnification change part 304 also changes the value of the interpolation coordinates of each frame time to the coordinates, the width, and the height of the standard image size using the same method as that of Step S232 and S235 (Step S236). Then, the frame image combination part 305 performs overlay drawing (overwrites pixels) of the frame image of the interpolation moving image v12 on the frame image of the reproduction moving image v10 (Step S237).

By performing the operation as described above, the interpolation processing section 218 that is included in the interpolation unit 210 according to Example 1 can perform interpolation combination on the interpolation moving image v12 of which only the interpolation region is set to be the moving image screen with the moving image screen of the reproduction moving image v10.

By performing interpolation combination on the interpolation moving image v12 of which only the interpolation region is set to be the moving image screen with the moving image screen of the reproduction moving image v10, the moving image screen of the interpolation moving image v12 has the minimum image size in which a region other than the entire interpolation region group of all frames is not included while including the entire interpolation region group of all frames. In the Example 1, the pixel amount of an interpolation moving image screen can be reduced to the minimum. In addition, even when the size of the interpolation region is changed for each frame, the size of the moving image screen of the interpolation moving image v12 is not changed, and thus the existing moving image encoding process and decoding process can be used.

Since the interpolation moving image v12 only includes the interpolation region and does not include a region not necessary for the interpolation process in Example 1, the image size of the interpolation moving image v12 can be smaller than the image size of the original high-quality moving image v11. Generally, in the moving image encoding scheme, as the size of an image decreases, an encoding rate necessary for maintaining the same moving image quality (as the original high-quality moving image v11) can be lowered, and thus the encoding rate of the interpolation moving image v12 can be lowered. Thus, in Example 1, the transmission rate of the interpolation moving image v12 can be lowered more than when the entire high-quality moving image v11 is transmitted. In addition, since the image size of the interpolation moving image v12 is small, a burden of the decoding process of the interpolation moving image v12 on the interpolation unit 210 is suppressed.

Among mobile devices and consumer devices, for example, there are devices on which only one hardware decoder is mounted. When Example 1 is applied to such a device, for example, the reproduction moving image v10 is decoded by the hardware decoder, and the interpolation moving image v12 that has the small size can be subject to a decoding process that is called software decoding (for example, decoding through an arithmetic operation of a CPU). Since the image size of the interpolation moving image v12 is small, the interpolation moving image v12 can be decoded in the software decoding.

In addition, in the example described above, the case in which the one interpolation moving image v12 is provided during the interpolation process of the one reproduction moving image v10 has been described, however, as described in the embodiment of the present disclosure described above, a plurality of interpolation moving images v12 may be simultaneously present for the one reproduction moving image v10. For example, for the reproduction moving image v10 of moving image content named “sport X,” the interpolation process may be performed using two interpolation moving images called “player A” and “player B.” In this case, the interpolation moving image selection section 214 of the interpolation unit 210 requests transmission of the interpolation moving images v12 of both “player A” and “player B” and the interpolation information i10 to the interpolation moving image transmission unit 130 through automatic determination using an instruction of a user, analysis of user preference, popularity on a network, and the like. According to reception of the plurality of interpolation moving images v12 and the interpolation information i10, the interpolation unit 210 processes the interpolation moving images v12 of “player A” and “player B” at the same time. In addition, the interpolation unit 210 can perform interpolation-combination on interpolation region images obtained from the two interpolation moving images v12 with a moving image screen of the reproduction moving image v10.

### 3. EXAMPLE 2

### Overview

Next, Example 2 of the embodiment of the present disclosure will be described. In Example 1, since the moving image screen of the interpolation moving image v12 is focused only on the interpolation region, when there are the plurality of interpolation regions (for example, two interpolation regions of “player A” and “player B”) for one reproduction moving image v10, the interpolation moving image v12 is divided for each of the interpolation regions. For this reason, when the plurality of interpolation regions are processed for the one reproduction moving image v10, the interpolation unit 210 decodes the interpolation moving image v12 once for each of the interpolation regions.

In Example 2 to be described below, the images of a plurality of interpolation regions fall within one interpolation moving image v12. Accordingly, if the interpolation moving image v12 is decoded once, the interpolation unit 210 can extract the images of all of the interpolation regions

FIG. 24 is a descriptive diagram showing an example of the relationship between the moving image screen of the interpolation moving image v12 and interpolation regions according to Example 2.

In Example 2, the image size of the moving image screen of the interpolation moving image v12 is set to be the same as the image size of the moving image screen of the original high-quality moving image v11. By setting the image size of the moving image screen of the interpolation moving image v12 to be the same as the image size of the moving image screen of the original high-quality moving image v11, a region of the moving image screen of the original high-quality moving image v11 that includes all of the interpolation regions is secured in the interpolation moving image v12.

Then, when creating each frame image of the interpolation moving image v12, the interpolation moving image generation unit 120 disposes as many of the pixel groups of regions corresponding to a frame image of the high-quality moving image v11 as the portions of the interpolation regions. Here, the coordinates in which the pixel groups are disposed are the coordinates on the moving image screen of the high-quality moving image v11 (in other words, the coordinate on the moving image screen of the interpolation moving image v12). The interpolation moving image generation unit 120 fills the region other than the interpolation regions of the interpolation moving image frame with invalid pixels.

In Example 2, the invalid pixels mean pixels that have a predetermined pixel value so as to be discarded during extraction of an interpolation image in the interpolation unit 210. For example, a value in the range of the value of luminance+color-difference (YCbCr, or the like), a maximum value of transparency of RGBA (RGB+α), or a value of a pixel that does not appear over all frames may be selected, or a specific pixel value may be decided as the value of the invalid pixels. The value of the invalid pixel is fixed to a value that does not change.

As a result, the frame image of the interpolation moving image v12 is formed to be a frame image in which the groups of valid pixels acquired from the corresponding regions of the high-quality moving image v11 are disposed only in the interpolation regions and the regions other than the interpolation regions are filled with the groups of invalid pixels. In addition, as the interpolation information i10, as many of the coordinates of the rectangular interpolation regions within the frame as the number of interpolation regions are described. In the example of FIG. 24, three interpolation regions are disposed in a certain frame, and the coordinates of three rectangular interpolation regions are also described in the interpolation information i10. The coordinates, the widths, and the heights of the interpolation regions are applied not only to the moving image screen of the original high-quality moving image v11 but also to the moving image screen of the interpolation moving image v12. This is because the image size of the moving image screen of the interpolation moving image v12 is set to be the same as the image size of the moving image screen of the original high-quality moving image v11 in the present example.

When the interpolation moving image v12 is encoded, the interpolation moving image generation unit 120 can maintain the quality of the image even though the image size thereof is the same as the high-quality moving image v11 (in the example of FIG. 24, 1920×1080) and the encoding rate of the encoding is lower than the encoding rate of the high-quality moving image v11. This is because, since the portion of the invalid pixels has the fixed value in the frame image, there is no change between adjacent macro blocks and frames, and accordingly the amount of information after the encoding is sharply reduced. Most information after the encoding is only information of an interpolation region portion of which the image changes. Thus, even if the encoding rate is decided based on a maximum area of the interpolation regions in which the total number of pixels of the groups of the interpolation regions within a frame among all frames, the quality of the encoded moving image is maintained.

In the example of FIG. 24, for example, among the three interpolation regions, the square interpolation region has 200×100=20000 pixels, the triangular interpolation region has 150×200/2=15000 pixels, the circular interpolation region has 80×80π=about 20000 pixels, and the sum of the pixels of the three interpolation regions is about 55000 pixels. Since the original high-quality moving image v11 has 1920×1080=2073600 pixels, the ratio of the pixels of the interpolation regions is 55000÷2073600=about 2.7%.

When the high-quality moving image v11 is encoded at 4 Mbps, for example, if the interpolation moving image generation unit 120 performs the encoding at 4 Mbps×2.7%=about 100 Kbps which is simply calculated in terms of the area ratio, interpolation moving image v12 can be expected to have an equivalent quality to the high-quality moving image v11. In addition, when noise is found due to a lowered encoding rate, the interpolation moving image generation unit 120 can perform the encoding considering the characteristic of the S/N ratio of the encoding scheme or set a lower limit on the encoding rate. Since the number of valid pixels is small even though the image size of the moving image screen of the interpolation moving image v12 is the same as the original high-quality moving image v11 as described above, the interpolation moving image generation unit 120 can encode the interpolation moving image v12 at a low encoding rate considering the number of valid pixels (the number of pixels in the interpolation regions) within the frame.

An overview of the interpolation unit 210 will also be described with reference to FIG. 24.

The interpolation unit 210 first decodes one frame of the interpolation moving image v12 when the images of the interpolation regions are extracted. As described above, if the interpolation unit 210 decodes one frame of the interpolation moving image v12 regardless of the number of interpolation regions, the images of all of the interpolation regions can be extracted.

Then, the interpolation unit 210 extracts the rectangular images that include the interpolation regions from the frame image of the interpolation moving image v12 based on the interpolation information i10. The coordinates, the widths, and the heights described in the interpolation information i10 are applied to the coordinates of the high-quality moving image v11 and the coordinates on the moving image screen of the interpolation moving image v12. This is because the image size of the moving image screen of the interpolation moving image v12 is set to be the same as the image size of the moving image screen of the original high-quality moving image v11 in the present example. In other words, the coordinates described in the interpolation information i10 are coordinates on the moving image screen of the interpolation moving image v12 in which the interpolation regions are subject to being extracted and coordinates (on the moving image screen of the high-quality moving image v11) in which interpolation images are disposed during the interpolation process.

Then, when invalid pixels are included in the extracted rectangular images, the interpolation unit 210 discards the portion of the invalid pixels, and then only performs interpolation combination on the remaining valid pixel group with the moving image screen of the reproduction moving image v10. In this manner, by removing the invalid pixels from the rectangular images extracted from the interpolation moving image v12, a non-rectangular interpolation region can also be expressed in the present example as shown in FIG. 24. For example, the interpolation unit 210 can extract an interpolation image in the shape of the body of a player, the face of a person, or the like.

Hereinabove, the overview of Example 2 according to the embodiment of the present disclosure has been described. Next, an operation example of the interpolation moving image generation unit 120 according to Example 2 will be described.

### [Operation Example of the Interpolation Moving Image Generation Unit]

FIGS. 20 to 22 are flowcharts showing the operation example of the interpolation moving image generation unit 120 according to Example 2. Note that a configuration of the interpolation moving image generation unit 120 according to Example 2 is assumed to be the same as shown in FIG. 2. Hereinafter, the operation example of the interpolation moving image generation unit 120 according to Example 2 will be described with reference to FIGS. 20 to 22.

The interpolation instruction unit 121 receives an input of interpolation instructions (Step S301). The interpolation instruction unit 121 acquires information of the interpolation instructions for individual frames of the high-quality moving image v11, and retains the interpolation instructions of all frames in the form of a file, a database, a memory, or the like. The information of the interpolation instructions includes frame times, and the (upper-left) coordinates and the size (the width and the height) of interpolation regions. In the present example, interpolation instructions for a plurality of regions of one frame may be input.

When the interpolation instruction unit 121 receives the input of the interpolation instructions, the interpolation information processing unit 123 obtains an interpolation region that has the maximum area (the maximum number of pixels) in a frame among the frame group of the high-quality moving image v11, and then decides an encoding rate of the interpolation moving image v12 (Step S302).

FIG. 21 is a flowchart showing details of an operation performed when the interpolation region that has the maximum area (the maximum number of pixels) in the frame is obtained in Step S302.

The interpolation information processing unit 123 first initializes the maximum interpolation area to 0 (Step S311). Next, the interpolation information processing unit 123 acquires an interpolation region group of one frame from the interpolation instruction unit 121 (Step S312).

Then, the interpolation information processing unit 123 calculates the area (the number of pixels) of each interpolation region of the frame, and sets the sum of the areas to be an interpolation region area (the number of pixels) of the frame (Step S313). It should be noted that, when there is an overlapping portion between the interpolation regions, it is better for the interpolation information processing unit 123 not to perform duplicated calculation on the overlapping portion. The area obtained in Step S313 is also referred to as an interpolation area.

Next, the interpolation information processing unit 123 compares the maximum interpolation area to the interpolation area obtained in Step S313, and if the interpolation area obtained in Step S313 is greater, the maximum interpolation area is updated with the value of the interpolation area obtained in Step S313 (Step S314).

The interpolation information processing unit 123 repeats the processes of Steps S312 to S314 up to the final frame (Step S315). When the processes are completed to the final frame, the interpolation information processing unit 123 decides the encoding rate of the interpolation moving image v12 based on the maximum interpolation area, and the area and the encoding rate of the original high-quality moving image v11 (Step S316). The interpolation information processing unit 123 may decide the encoding rate using the ratio of the area of the high-quality moving image v11 to the maximum interpolation area as described above, may nonlinearly calculate the encoding rate according to the S/N ratio of the encoding scheme, or may set the lowest value of the encoding rate.

Description will be provided returning to FIG. 20. When the encoding rate of the interpolation moving image v12 is decided, the frame image extraction unit 124 generates the interpolation moving image v12 from the high-quality moving image v11 (Step S303).

FIG. 22 is a flowchart showing details of the operation performed when the interpolation moving image v12 is generated from the high-quality moving image v11 in Step S303.

The decoding unit 122 decodes one frame of the high-quality moving image v11 (Step S321). The image size of the high-quality moving image v11 is set by the width HW and the height HH. When the decoding unit 122 decodes one frame of the high-quality moving image v11, the frame image extraction unit 124 then prepares a frame buffer for the interpolation moving image v12 (Step S322). The image size of the frame buffer including the width MW and the height MH is set to be the same as the image size of the high-quality moving image v11 (the width HW and the height HH). In addition, the frame image extraction unit 124 fills the prepared frame buffer with invalid pixels. The frame image extraction unit 124 disposes as many pixel groups of the interpolation regions in the frame buffer as the number of interpolation regions instructed for the frame.

After the frame buffer is prepared and filled with the invalid pixels, the frame image extraction unit 124 then acquires a region in which interpolation is instructed from the interpolation information processing unit 123 (Step S323).

When the frame image extraction unit 124 acquires the region in which interpolation is instructed from the interpolation information processing unit 123, a pixel group of the instructed region is extracted from the frame image of the high-quality moving image v11 obtained from the decoding process of Step S321, and then disposed in the frame buffer for an interpolation region (Step S324). The coordinates, the widths, and the height of the disposition are assumed to be the same as those of the high-quality moving image v11.

The frame image extraction unit 124 repeats the process of Step S324 once for each of the interpolation regions instructed for the frame (Step S325). After the process of Step S324 is repeated once for each of the interpolation regions instructed for the frame, the encoding unit 125 performs a post-process for one frame, thereby generating the interpolation moving image v12 (Step S326).

In the frame buffer generated by the frame image extraction unit 124, the pixel group of the high-quality moving image v11 is disposed in the interpolation region group, and the invalid pixel group is disposed in the region other than the interpolation region group. The encoding unit 125 encodes the frame buffer at the encoding rate obtained in Step S302, thereby generating the interpolation moving image v12.

The interpolation information processing unit 123 records information on the interpolation regions of the frame in the interpolation information i10. The recorded information includes the frame time (or the frame number), and the coordinates, the widths, and the height of the rectangular interpolation regions. The values are values on the moving image screen of the high-quality moving image v11 and values on the moving image screen of the interpolation moving image v12. When a plurality of interpolation regions are present in one frame, the interpolation information processing unit 123 records information of the plurality of interpolation regions as shown in FIG. 24 as the interpolation information i10.

The processes of Steps S321 to S326 are repeated to the final frame.

By executing the operation shown in FIGS. 20 to 22, the interpolation moving image generation unit 120 according to Example 2 can create the interpolation moving image v12 in which the pixel groups of the high-quality moving image v11 are disposed in the interpolation regions and the invalid pixels are disposed in the region other than the interpolation region and the interpolation information i10 in which information of one or the plurality of pixel groups is described for each frame. The interpolation moving image v12 and the interpolation information i10 created by the interpolation moving image generation unit 120 are transmitted to and stored in the interpolation moving image transmission unit 130.

Hereinabove, the operation example of the interpolation moving image generation unit 120 according to Example 2 has been described with reference to FIGS. 20 to 22. Since an operation of the interpolation moving image transmission unit 130 according to Example 2 is the same as the operation example shown in FIGS. 6 and 7, detailed description thereof will be omitted herein. Next, an operation example of the interpolation unit 210 according to Example 2 will be described.

### [An Operation Example of the Interpolation Unit]

FIG. 23 is a flowchart showing the operation example of the interpolation unit 210 according to Example 2. It should be noted that a configuration of the interpolation unit 210 according to Example 2 is assumed to be the same as that shown in FIG. 4. Hereinafter, the operation example of the interpolation unit 210 according to Example 2 will be described with reference to FIG. 23.

FIG. 23 shows details of the interpolation process of Step S133 of FIG. 8. The decoding section 215 that decodes the reproduction moving image v10 decodes one frame of the reproduction moving image v10, thereby generating a decoded frame image (Step S331). In addition, the decoding section 215 transfers the frame time (frame number) of the frame decoded this time to the time control section 217.

The decoding section 216 that decodes the interpolation moving image v12 decodes one frame of the interpolation moving image v12, thereby generating a decoded frame image (Step S333). In addition, the decoding section 216 transfers the frame time (frame number) of the frame decoded this time to the time control section 217.

The time control section 217 matches the times so that the frame times of the reproduction moving image v10 and the interpolation moving image v12 are synchronized (Steps S331 and S333).

When the frame times of the reproduction moving image v10 and the interpolation moving image v12 are synchronized by the time control section 217, the interpolation region extraction part 303 then extracts the image of an interpolation region from the frame image of the interpolation moving image v12. The extraction of the image of the interpolation region is performed as follows.

The interpolation region extraction part 303 acquires the coordinates [x, y], the width MW, and the height MH of the interpolation region from interpolation information of the frame time of the frame to be extracted, and then extracts a pixel group of the region from the frame image of the interpolation moving image v12 (Step S334).

Then, the interpolation region extraction part 303 discards an invalid pixel group from the extracted pixel group (interpolation image) (Step S335). For example, if the image format of the image to be processed is an image format that has an alpha channel, the interpolation region extraction part 303 sets transparency of the extracted pixel group (interpolation image) to be the maximum. In addition, if the image format of the image to be processed is an image format that does not have an alpha channel, for example, the invalid pixels are skipped later during interpolation composition.

When the interpolation region extraction part 303 extracts the image of the interpolation, the image magnification change parts 301 and 304 enlarge or reduce the decoded frame images of the reproduction moving image v10 and the interpolation moving image v12 so as to fit the standard image size (Steps S332 and S336). Since the processes of Steps S332 and S336 are the same as those of Steps S143 and S146 in FIG. 9, detailed description thereof is omitted.

When the image magnification change parts 301 and 304 enlarge or reduce the decoded frame images of the reproduction moving image v10 and the interpolation moving image v12, the image magnification change part 304 also changes values of the interpolation coordinates of each frame time so as to fit the coordinates, the width, and the height of the standard image size in the same manner as Steps S332 and S336 (Step S337).

The processes of Steps S334 to S337 described above are repeated for interpolation regions of all frames to be processed (Step S338).

The frame image combination part 305 performs overlay drawing (overwriting of pixels) of the frame image of the interpolation moving image v12 of which magnification has been changed in accordance with the coordinate system of the standard image size on the frame image of the reproduction moving image v10 of which magnification has been likewise changed in accordance with the coordinate system of the standard image size (Step S339). When there are a plurality of interpolation regions, the frame image combination part 305 performs overlay drawing (overwriting of pixels) as many times as the number of the interpolation regions. As described for Step S335, depending on the format of the frame images, the frame image combination part 305 may skip the invalid pixels in the drawing stage of Step S339, and may combine valid pixels only.

By operating as described above, the interpolation processing section 218 that is included in the interpolation unit 210 according to Example 2 can perform interpolation combination on the interpolation moving image v12 that only has interpolation regions as moving image screens with a moving image screen of the reproduction moving image v10 even when one frame has the plurality of interpolation regions.

In Example 2, even if one frame has the plurality of interpolation regions, the interpolation moving image v12 is set to be one, and an encoding rate thereof can be lowered more than that of the high-quality moving image v11 according to the area of the interpolation regions. For example, as hardware capacity of mobile devices and consumer devices improves, hardware decoding of two moving images can be performed at the same time. A device that has such a configuration is configured to perform hardware decoding of two moving images of the reproduction moving image v10 and the interpolation moving image v12 of Example 2 at the same time, and thereby the reproduction moving image v10 can be interpolated with a plurality of interpolation regions while hardware decoded groups are effectively used.

A plurality of interpolation moving images v12 may be created for one piece of moving image content. For example, for moving image content of “sport X,” the interpolation moving image v12 of only “player A,” or the interpolation moving image v12 of “player A and player B” may also be created. When the plurality of interpolation moving images v12 are created for one piece of moving image content, the interpolation moving image selection section 214 of the interpolation unit 210 may cause a user to select the interpolation moving image v12 by enumerating interpolation names, automatically select the interpolation moving image v12 based on preference of viewers or popularity on the Internet, or recommend the interpolation moving image to the user.

In addition, in Example 2, the plurality of interpolation regions are included in the one interpolation moving image v12, however, the interpolation unit 210 may execute the interpolation process using the plurality of interpolation moving images v12 at the same time. For example, when there are 10 players in the content of a sport moving image, a plurality of interpolation moving images that include interpolation region groups with two to three players are created by the interpolation moving image generation unit 120 in advance. The interpolation unit 210 may perform the interpolation process on the interpolation moving image v12 of “player A and player B” and the interpolation moving image v12 of “player M and player N” among the groups at the same time.

In addition, in Example 2 described above, the coordinates, the width, and the height of the interpolation regions on each frame screen of the interpolation moving image v12 are set to be described in the interpolation information i10, but the interpolation information i10 may not be provided. When the interpolation information i10 is not provided, the interpolation moving image generation unit 120 only generates the interpolation moving image v12, and does not generate the interpolation information i10. The interpolation moving image transmission unit also retains the interpolation moving image v12 only, and transmits the interpolation moving image to the reproduction device 200.

In addition, when the interpolation information i10 is not provided, the interpolation processing section 218 of the interpolation unit 210 scans all pixels of the decoded frame image of the interpolation moving image v12 and then only extracts valid pixels. When an interpolation image is extracted from the frame image of the interpolation moving image v12 by hardware, scanning all pixels and only extracting the valid pixels may contribute to simplification and speed-up of a circuit. On the other hand, when the interpolation image is extracted from the frame image of the interpolation moving image v12 by a program, pre-provision of information on patterns of which pixels should be extracted may contribute to optimization of a process. The screen size of the original high-quality moving image v11 that is necessary for conversion into the standard image size can be replaced by the screen size of the interpolation moving image v12, rather than being obtained from the interpolation information i10. This is because the screen size of the original high-quality moving image v11 is the same as the screen size of the interpolation moving image v12 in Example 2.

As described above, by filling the interpolation moving image v12 with the plurality of interpolation regions and the region other than the interpolation regions with the invalid pixels, Example 2 is advantageous in that decoding of the one interpolation moving image v12 is enough even though there are the plurality of interpolation regions. Particularly, this advantage can be utilized when the interpolation process is executed in a device that can perform hardware decoding on two moving images at the same time as described above. In addition, in Example 2, a non-rectangular interpolation region can also be expressed. Since the invalid pixels are discarded during the interpolation process, even though the interpolation moving image screen v12 has a rectangular shape, an interpolation image to be used in interpolation (after the invalid pixels are discarded) has an arbitrary shape. For example, the interpolation region can be fit to the body shape of a player, or fit to the shape of the face of a person as a result of face recognition, and accordingly, the present example can perform a more natural interpolation process.

Note that the content of Example 2 can also be applied to Example 1. By applying the content of Example 2 to Example 1, effects that such a non-rectangular interpolation region can be expressed, an amount of information of a non-interpolation region can be reduced, and it is not necessary to separately manage the coordinates of interpolation moving image screens are exhibited in Example 1.

FIG. 26 is a descriptive diagram showing the effects exhibited when the content of Example 2 is applied to Example 1. By applying the content of Example 2 to Example 1, the moving image reproduction system 1 according to the present embodiment can express a non-rectangular interpolation region as shown by Frame 0. In Example 1, only an interpolation region is set to be the interpolation moving image v12. By applying the content of Example 2 to Example 1, the moving image reproduction system 1 according to the present embodiment disposes invalid pixels in the moving image screen of the interpolation moving image v12 and during interpolation-combination by the interpolation unit 210, can perform interpolation-combination on an interpolation region in an arbitrary shape.

In the example of Frame 0 of FIG. 26, in order to express a circular interpolation region, a rectangle that includes the circular interpolation region is set to be a moving image screen of the interpolation moving image v12, and the portion other than the circular interpolation region is filled with invalid pixels. By applying the content of Example 2 to Example 1, the moving image reproduction system 1 according to the present embodiment can perform interpolation-combination on the circular interpolation region by removing the invalid pixels during the interpolating combination performed by the interpolation unit 210.

By applying the content of Example 2 to Example 1, the moving image reproduction system 1 according to the present embodiment can reduce the amount of information of a non-interpolation region as shown by Frame 1. In Example 1, the image size of the interpolation region changes for each frame, and on the other hand, the image size of the moving image screen of the interpolation moving image v12 is fixed as described in FIG. 17. For this reason, in Example 1, the image size of the moving image screen of the interpolation moving image v12 is the maximum width×the maximum height of the interpolation region group of all frames. For this reason, even if the size of an interpolation region of a frame is small, pixel information on the region other than the small interpolation region is given to the frame of the interpolation moving image v12.

By applying the content of Example 2 to Example 1, in each frame image of the interpolation moving image v12 in the moving image reproduction system 1 according to the present embodiment, the region other than the interpolation region of the frame is filled with invalid pixels, thus the value of the invalid pixel portion is not changed, and therefore the amount of information during encoding of the moving image of the frame can be reduced.

In the example of Frame 1 in FIG. 26, the moving image screen of the interpolation moving image v12 has the image size of MW=100 and MH=100 which are the maximum width and the maximum height of all frames. When an interpolation region of a frame has the size of the width 50×the height 60 which is smaller than the above image size, the moving image reproduction system 1 according to the present embodiment can reduce the amount of information when encoding the frame by filling the region other than the interpolation region with invalid pixels.

By applying the content of Example 2 to Example 1, it is not necessary to separately manage the coordinates of interpolation moving image screens as indicated by Frame 2 in the moving image reproduction system 1 according to the present embodiment. In Example 1, when the interpolation region is positioned on the right end or the left end of the moving image screen of the high-quality moving image v11 as described in FIG. 18, there is a case in which the moving image screen of the interpolation moving image v12 runs over the moving image screen of the high-quality moving image v11 due to the image size of the moving image screen of the interpolation moving image v12 being fixed. For this reason, in order not to make the moving image screen of the interpolation moving image v12 run over the moving image screen of the high-quality moving image v11 by deviating the moving image screen of the interpolation moving image v12 on the left or the upper side, the coordinates of the interpolation region are separately managed from those of the moving image screen of the interpolation moving image v12.

By applying the content of Example 2 to Example 1, the moving image reproduction system 1 according to the present embodiment can collectively manage the coordinates of the moving image screen of the interpolation moving image v12 and the interpolation region while fixing the image size of the moving image screen of the interpolation moving image v12 by filling the run-over region with invalid pixels even when the moving image screen of the interpolation moving image v12 runs over the moving image screen of the high-quality moving image v11.

In the example of Frame 2 of FIG. 26, while the image size of the moving image screen of the interpolation moving image v12 is MW=100×MH=100, the coordinates of the interpolation region are [1840, 1000]. If the pixel group of 100×100 is extracted as it is in that state, the moving image screen of the interpolation moving image v12 runs over the moving image screen of the high-quality moving image v11. Thus, the moving image reproduction system 1 according to the present embodiment may manage only the coordinates of one kind of the run-over region (in other words, the region other than the interpolation region) without necessitating deviation of the coordinates of the moving image screen of the interpolation moving image v12 from the coordinates of the interpolation region and referring to the pixel group of the moving image screen of the high-quality moving image v11.

FIG. 25 is a flowchart showing an operation example of the interpolation moving image generation unit 120 performed when the content of Example 2 is applied to Example 1. FIG. 25 shows the operation example of the interpolation moving image generation unit 120 performed when the image of the moving image screen of the interpolation moving image v12 is extracted from the high-quality moving image v11.

First, the decoding unit 122 decodes one frame of the high-quality moving image v11 and delivers the decoded frame image to the frame image extraction unit 124 in the same manner as Step S221 of FIG. 15. In addition, the time of the decoded frame (or the frame number) and the image size of the frame (the width HW and the height HH) are delivered to the interpolation information processing unit 123 (Step S341).

The interpolation information processing unit 123 acquires interpolation region instruction information corresponding to the time of the decoded frame from the interpolation instruction unit 121 (Step S342). Here, the coordinates of the upper-left portion of the instructed interpolation region (on the moving image screen of the high-quality moving image v11) are set to be [x, y], the width thereof is set to be DW, and the height thereof is set to be DH.

Next, the frame image extraction unit 124 prepares a frame buffer of the moving image screen of the interpolation moving image v12. The width MW and the height MH of the frame buffer are the image size decided in Step S202 of FIG. 13. Then, the frame image extraction unit 124 fills the frame buffer with invalid pixels (Step S343).

Next, the frame image extraction unit 124 extracts the pixel group of the interpolation region from the high-quality moving image v11, and then disposes the pixel group in the frame buffer of the moving image screen of the interpolation moving image v12 (Step S344). The frame image extraction unit 124 extracts the pixel group having the coordinates [x, y] on the high-quality moving image and the size (the width DW×the height DH). Then, the frame image extraction unit 124 disposes the extracted pixel group beginning from the coordinates [0, 0] of the frame buffer of the moving image screen of the interpolation moving image v12.

Accordingly, on the moving image screen of the width MW×the height MH of the interpolation moving image v12, valid pixels are disposed in the interpolation region (the width DW×the height DH) and invalid pixels are disposed in the region other than the interpolation region, and thereby the frame image of the moving image screen of the interpolation moving image v12 of which the image size is fixed to the width MW×the height MH is created.

Next, the encoding unit 125 encodes the frame image of the moving image screen of the interpolation moving image v12 generated in Step S344 into a moving image (Step S345). The encoding rate in Step S345 is decided based on the maximum interpolation area among an interpolation region group of all frames and the area and the encoding rate of the original high-quality moving image. As described above, the encoding unit 125 may decide the rate according to an area ratio, may nonlinearly calculate the rate according to the S/N ratio of the encoding scheme, or may set the lowest encoding rate. The interpolation moving image area is used in Example 1, but when Example 2 is applied to Example 1, the area of the interpolation region that is included within the moving image screen can be used, and thus the encoding rate is further lowered.

In addition, as the interpolation information i10, the frame time (or the frame number), and the coordinates [x, y] and the size DW×DH of the interpolation region are described. Since the coordinates of the moving image screen of the interpolation moving image v12 are the same as the upper-left coordinates of the interpolation region, the coordinates of the interpolation moving image may not be separately described unlike in Example 1.

It should be noted that the size DW×DH may not be described in the interpolation information i10. The interpolation processing section 218 can extract the valid pixels only if the invalid pixels are discarded from the frame image of the moving image screen of the interpolation moving image v12 regardless of whether the information on the size is provided. When extraction of an interpolation image from the frame image of the interpolation moving image v12 is performed by hardware as in Example 2, simple scanning of pixels can simplify a circuit, and when extraction is performed by software, optimization of the process can be obtained through pre-provision of information on the rectangle.

As described above, by applying Example 2 to Example 1, the moving image reproduction system 1 according to the present embodiment can express a non-rectangular interpolation region, improve encoding efficiency by reducing the amount of information of a non-interpolation region, and collectively manage the coordinates of an interpolation moving image and the interpolation region.

### 4. EXAMPLE 3

### Overview

Next, another example of the moving image reproduction system 1 according to the embodiment of the present disclosure will be described. In Example 3, the interpolation moving image v12 is not created according to every interpolation instruction, but a screen region of the high-quality moving image v11 is divided into, for example, a plural number in a tile shape to prepare in advance a divided-screen moving image group in which each rectangular tile (divided screen) is set to be a moving image and the divided-screen moving image group is set to be the interpolation moving image v12. Then, from an interpolation instruction, only interpolation information i10 in which an interpolation region for each frame is recorded is generated. The interpolation unit 210 acquires the divided-screen moving image (interpolation moving image v12) group corresponding to the interpolation region, extracts the pixel group of the interpolation region from the divided-screen moving image group, and then performs interpolation combination on the pixel group.

In Example 3, the moving image reproduction system according to the embodiment of the present disclosure exhibits effects that the number of interpolation moving images can be maintained uniform at all times, and the interpolation moving image v12 corresponding to an interpolation region can be promptly acquired by generating the interpolation moving image in advance regardless of an interpolation instruction.

FIGS. 32 to 34 are descriptive diagrams showing overviews of operations of Example 3.

The interpolation moving image generation unit 120 divides the screen of the high-quality moving image v11 into a plurality of partial screens in advance as shown in FIG. 32 regardless of presence or absence of an interpolation instruction. Here, for the sake of convenience in description, each divided rectangular partial screen is referred to as a “tile.” In other words, the interpolation moving image generation unit 120 divides the screen of the high-quality moving image v11 into TX tiles in the horizontal direction and TY tiles in the vertical direction.

Then, the interpolation moving image generation unit 120 generates the divided-screen moving image group by performing moving image encoding for each tile on all frames of the high-quality moving image v11, and treats the divided-screen moving image group as a group of the interpolation moving images v12. If the screen is divided into TX×TY, TX×TY divided-screen moving images (interpolation moving images) are generated by the interpolation moving image generation unit 120, and each of the interpolation moving images v12 forms a moving image screen in the tile region corresponding to the original high-quality moving image v11.

For example, if the image size of the original high-quality moving image v11 is 1024×768 and the number of divided screens is 4 in the horizontal direction×3 in the vertical direction as shown in FIG. 32, the moving image screen of the high-quality moving image v11 is divided into 4×3=12 tiles, and accordingly 12 divided-screen moving images (=interpolation moving images) are also generated. In addition, the image size of each tile is 1024/4=256 in the horizontal direction and 768/3=256 in the vertical direction, and accordingly the divided-screen moving image (interpolation moving image v12) group has moving image screens corresponding to each tile region and the image size of each moving image is the image size of each tile.

Hereinafter, for the sake of convenience in description, each of the tiles and divided-screen moving images (interpolation moving images) is numbered by adding 0, 1, 2, and 3 to the tiles from left to right and 0, 1, and 2 from top to bottom in order. For example, the tile (divided-screen moving image) on the upper-left side is <horizontal 0, vertical 0> and the tile (divided-screen moving image) on the lower-right side is <horizontal 3, vertical 2>

A difference of Example 3 from Examples 1 and 2 is that the group of the interpolation moving images v12 is obtained by dividing the moving image screen of the high-quality moving image v11 into a fixed number and can be generated in advance independently by the interpolation moving image generation unit 120 regardless of an interpolation instruction.

Likewise in the examples described above, enumeration of the frame times (or the frame numbers), the interpolation coordinates, the width, and the height of the frames is described in the interpolation information i10. In Example 3, the interpolation moving image v12 dedicated to and forming a pair with the interpolation information i10 is not provided, and the divided-screen moving image group described above forms the (group of) interpolation moving images v12. Even though there are a plurality of pieces of the interpolation information i10 for one piece of moving image content (the high-quality moving image v11), only one set of the divided-screen moving image group is provided and shares the information in the interpolation information i10.

On the other hand, the interpolation unit 210 acquires information on the divided-screen moving image group that includes the interpolation moving images v12 and the interpolation information i10 from the interpolation moving image transmission unit 130. The information on the divided-screen moving image group includes the image size of the original high-quality moving image v11, the number of horizontal and vertical divisions, the location (for example, URL) of each divided-screen moving image, and the like. Based on the information transmitted from the interpolation moving image transmission unit 130, the interpolation unit 210 can recognize which tile belongs to which coordinates on the screen.

FIG. 33 shows a combination process performed by the interpolation unit 210 when one tile includes an entire interpolation region. The interpolation unit 210 acquires information (the coordinates, the width, and the height) on an interpolation region of a frame (0^{th} frame) from the interpolation information i10. For example, the interpolation region of the 0^{th} frame is assumed to have the coordinates of [260, 600], the width of 100, and the height of 100 as shown in FIG. 33. The interpolation unit 210 can determine from the information of the divided-screen moving image group that the coordinates [260, 600] belong to the tile <1, 2>. In addition, the coordinates of the lower-right corner of the interpolation region are [360, 700] and fall within the region of the tile <1, 2>, and thus the interpolation unit 210 understands that the image of the interpolation region can be acquired from the divided screen of the tile <1, 2>.

Then, the interpolation unit 210 acquires the divided-screen moving image of the tile <1, 2> from the interpolation moving image transmission unit 130, decodes the divided-screen moving image of the acquired tile <1, 2>, and thereby obtaining the frame image of the 0^{th} frame. The tile <1, 2> is a region having the size of 256×256 from the coordinates [256, 512] of the high-quality moving image v11. The interpolation unit 210 extracts the pixel group of 100×100 in the coordinates [260-256, 600-512] within the frame image, and then performs interpolation combination on the pixel group with the reproduction moving image v10.

FIG. 34 shows a combination process performed by the interpolation unit 210 when an interpolation region spans a plurality of tiles. The interpolation unit 210 acquires information (the coordinates, the width, and the height) on an interpolation region of a frame (1^{st} frame) from the interpolation information i10. For example, the interpolation region of the 1^{st} frame is assumed to have the coordinates of [450, 550] and the size of the width of 100, and the height of 100 as shown in FIG. 34. The interpolation unit 210 can determine from the information of the divided-screen moving image group that the upper-left portion of the interpolation region is positioned in the region of the tile <1, 2> but the coordinates [550, 650] of the lower-right portion are positioned in the region of the tile <2, 2>. In other words, the interpolation region spans the tile <1, 2> and the tile <2, 2>. Thus, the interpolation unit 210 acquires the divided-screen moving image of the tile <1, 2> and the divided-screen moving image of the tile <2, 2> from the interpolation moving image transmission unit 130. The tile <2, 2> is a region having the size of 256×256 from the coordinates [512, 512] of the original high-quality moving image.

Then, the interpolation unit 210 decodes the two divided-screen moving images of the tile <1, 2> and the tile <2, 2>, thereby obtaining the frame image of the 1^{st} frame. As shown in FIG. 34, the left portion of the interpolation region is in the tile <1, 2> and a case in which a region having the width of 100 and the height of 100 is extracted from the coordinates [450, 550] as the interpolation region is considered. The interpolation unit 210 can extract the left portion of the interpolation region having the coordinates in the frame image [the left coordinate of the interpolation region 450—the left coordinate of the tile 256, the upper coordinate of the interpolation region 550—the upper coordinate of the tile 512]=[194, 38] and the size of the width (the right coordinate of the tile 512—the left coordinate of the interpolation region 450)×the height 100. In addition, the right portion of the interpolation region is in the tile <2, 2>, and the interpolation unit 210 can extract the right portion of the interpolation region having the coordinates in the frame image [0, 38] and the size of the width (the right coordinate of the interpolation region (450+100)—the left coordinate of the tile 512)×the height 100. The interpolation unit 210 can generate the image of the interpolation region from the frame image of the two tiles by acquiring pixel groups of the two regions as described above and connecting the pixel groups side by side. The interpolation unit 210 uses the generated image of the interpolation region in interpolation combination with the reproduction moving image v10.

As described above, the interpolation unit 210 uses the same divided-screen moving image group for any of the interpolation information i10 to acquire a group of divided-screen moving images corresponding to a tile to which an interpolation region belongs based on the coordinates, the width, and the height of the interpolation region, rather than using the interpolation moving image v12 (dedicated to the interpolation information i10) making a pair with the interpolation information i10, and then extracts the pixel group of the interpolation region from a frame image.

### [Functional Configuration Example of the Interpolation Moving Image Generation Unit]

Next, a functional configuration example of the interpolation moving image generation unit 120 according to Example 3 will be described. FIG. 27 is a descriptive diagram showing the functional configuration example of the interpolation moving image generation unit 120 according to Example 3 of the embodiment of the present disclosure.

Unlike in Examples 1 and 2 described above, in Example 3, the moving image screen of the high-quality moving image v11 is divided into a designated number of screens in advance, rather than creating the interpolation moving image v12 according to each interpolation instruction, and a group of the interpolation moving images v12 in which each divided tile is set to be a moving image screen is generated independently of such an interpolation instruction. The interpolation information i10 is generated by the interpolation instruction unit 121 as in Examples 1 and 2 described above and the coordinates and the size of the interpolation region of each frame are recorded therein.

Thus, in Example 3, the interpolation information is not delivered from the interpolation instruction unit 121 to the frame image extraction unit 124 unlike in Examples 1 and 2 described above. In addition, the interpolation moving image generation unit 120 according to Example 3 is configured to include a frame image dividing unit 126 instead of the frame image extraction unit 124. The frame image dividing unit 126 divides the moving image screen of the high-quality moving image v11 in a designated number of screens. The high-quality moving image v11 divided by the frame image dividing unit 126 is encoded by the encoding unit 125, and thereby the group of the interpolation moving images v12 in which each tile is set to be a moving image screen is obtained.

### [Functional Configuration Example of the Interpolation Moving Image Transmission Unit]

Next, the functional configuration example of the interpolation moving image transmission unit 130 according to Example 3 will be described. FIG. 28 is a descriptive diagram showing the functional configuration example of the interpolation moving image transmission unit 130 according to Example 3 of the embodiment of the present disclosure.

A configuration of the interpolation moving image transmission unit 130 according to Example 3 is not different from that of the interpolation moving image transmission unit 130 according to Examples 1 and 2 described above. However, the way of managing the interpolation moving image v12 and the interpolation information i10 by the interpolation recording unit 132 is different. The interpolation recording unit 132 of the interpolation moving image transmission unit 130 according to Example 3 manages the group of the interpolation moving images v12′ (the divided-screen moving image group) in association with moving image content, rather than managing the interpolation moving images v12′ by making a pair with the interpolation information i10.

With regard to the [moving image content X], for example, the interpolation recording unit 132 manages and retains the group of the interpolation moving images v12′ divided into in a total of 12 including TX of 4 in the horizontal direction×TY of 3 in the vertical direction in association with the [moving image content X]. The interpolation recording unit 132 also manages the interpolation information i10 in association with the [moving image content X] in parallel with retaining the group of the interpolation moving images v12′ in association with the [moving image content X].

As shown in FIG. 3, for example, when there are an interpolation instruction of [player A] and an interpolation instruction of [player B], the interpolation recording unit 132 manages and retains the interpolation information i10 of both players. The number of divided screens and the stored location (for example, URL or the like) of the interpolation moving images v12′ corresponding to each tile are added to the information managed by the interpolation recording unit 132. The information managed by the interpolation recording unit 132 is delivered to the interpolation unit 210 during the interpolation process performed by the interpolation unit 210. The interpolation unit 210 also uses the information of the number of divided screens and the stored location (for example, URL or the like) of the interpolation moving images v12′ corresponding to each tile when selecting the interpolation moving image v12′ corresponding to the interpolation region.

### [Functional Configuration Example of the Interpolation Unit]

Next, a functional configuration example of the interpolation unit 210 according to Example 3 will be described. FIG. 29 is a descriptive diagram showing the functional configuration example of the interpolation unit 210 according to Example 3 of the embodiment of the present disclosure.

A configuration of the interpolation unit 210 according to Example 3 is not different from the configuration of the interpolation unit 210 according to the embodiment of the present disclosure shown in FIG. 4. However, the content of the process performed in the interpolation processing section 218 is different. In Example 3, the interpolation processing section 218′ decides the (one or a plurality of) interpolation moving images v12′ of a tile corresponding to an interpolation region based on the interpolation region within a frame image obtained from the interpolation information i10, and a process of instructing the reception section 212 such that the interpolation moving image transmission unit 130 transmits the (one or a plurality of) interpolation moving images v12′.

### [Operation Example of the Interpolation Moving Image Generation Unit]

Next, an operation example of the interpolation moving image generation unit 120′ according to Example 3 will be described. FIG. 30 is a descriptive diagram showing the operation example of the interpolation moving image generation unit 120′ according to Example 3 of the embodiment of the present disclosure.

The decoding unit 122 decodes one frame of the high-quality moving image v11 (Step S401). The image size of the high-quality moving image v11 is assumed to be the width HW×the height HH. In addition, the pre-designated number of divided screens is assumed to be TX in the horizontal direction×TY in the vertical direction. The image size of each tile obtained by the screen division is assumed to be HW/TX=TW for the width and HH/TY=TH for the height.

When the decoding unit 122 decodes one frame of the high-quality moving image v11 in Step S401, the frame image dividing unit 126 then divides the decoded frame image into TX tiles in the horizontal direction and TY tiles in the vertical direction. The frame image dividing unit 126 first initializes a counter y of the tile row (for example, initialize the value to 0) (Step S402).

Next, the frame image dividing unit 126 generates tiles of one horizontal line. The frame image dividing unit 126 initializes a counter x of the tile column (for example, initializes the value to 0) (Step S403).

Next, the frame image dividing unit 126 extracts a pixel group of a tile <x, y>. To be specific, the frame image dividing unit 126 extracts the pixel group of the region size (the width TW×the height TH) from the frame image of the high-quality moving image v11 decoded by the decoding unit 122 in Step S401 from the coordinates [x×TW, y×TH]. When the frame image dividing unit 126 extracts the pixel group, the encoding unit 125 then encodes the pixel group as the divided-screen moving image (interpolation moving image v12) of the tile <x, y> (Step S404).

When the encoding unit 125 performs the encoding in Step S404, the frame image dividing unit 126 then increases the counter x of the tile column by one (Step S405). The frame image dividing unit 126 determines whether or not x is greater than the number of horizontal divisions TX (Step S406), and when x is not greater than the number, the processes of Steps S404 and S405 are repeated, and then as many tiles of divided-screen moving images (interpolation moving images v12) as in one horizontal line are generated.

When x is greater than the number of horizontal divisions TX, the encoding unit 125 then increases the counter y of the tile row by one (Step S407). The frame image dividing unit 126 determines whether or not y is greater than the number of vertical divisions TY (Step S408), and when y is not greater than the number, the process returns to Step S403. When y is greater than the number of vertical divisions TY, the frame image dividing unit 126 finishes the division process for the frame image. The interpolation moving image generation unit 120 executes the process shown in FIG. 30 on all frames.

By executing the process shown in FIG. 30, the interpolation moving image generation unit 120 can generate the divided-screen moving images (the group of the interpolation moving images v12) in which the tiles obtained by dividing the moving image screen of the high-quality moving image v11 into TX tiles in the horizontal direction and TY tiles in the vertical direction are set to be moving image screens. In addition, the interpolation moving image generation unit 120 generates the interpolation information i10 from an interpolation instruction from the interpolation instruction unit 121 as described above in parallel with the process shown in FIG. 30. As described above, in Example 3, the interpolation moving image v12 that makes a pair with the interpolation information is not generated.

Hereinabove, the operation example of the interpolation moving image generation unit 120 according to Example 3 has been described. Since an operation of the interpolation moving image transmission unit 130 according to Example 3 is the same as the operation example shown in FIGS. 6 and 7, detailed description thereof is omitted herein. Next, an operation example of the interpolation unit 210 according to Example 3 will be described.

### [Operation Example of the Interpolation Unit]

Next, the operation example of the interpolation unit 210 according to Example 3 will be described. FIG. 31 is a descriptive diagram showing the operation example of the interpolation unit 210 according to Example 3 of the embodiment of the present disclosure.

When the reception section 211 receives the reproduction moving image v10, the decoding section 215 decodes the reproduction moving image v10, and thereby a frame image is generated. The decoding section 215 transmits the frame time (frame number) of the frame image to the interpolation coordinate calculation part 302 (Step S411). The interpolation coordinate calculation part 302 decides (one or a plurality of) interpolation moving images v12 corresponding to an interpolation region of the frame, and requests acquisition of the interpolation moving images v12 (Step S413). The method of deciding the (one or the plurality of) interpolation moving images v12 corresponding to the interpolation region of the frame image is as described above, but a method that will be described below is applicable.

When the image size of the high-quality moving image v11 is HW×HH and the number of divided screens is TX×TY, the interpolation coordinate calculation part 302 finds the number of horizontal and vertical tiles (interpolation moving images v12) and the image size of TW×TH. In addition, if a tile number is set to be <tx, ty>, the interpolation coordinate calculation part 302 finds the upper-left coordinates [tx×TW, ty×TH] of each tile.

When the upper-left coordinates of the interpolation region are set to be [x, y] and the size thereof is set to be MW×MH, the upper-left coordinates of the interpolation region are [x, y], the lower-left coordinates are [x+MW, y], the lower-left coordinates are [x, y+MH], and the lower-right coordinates are [x+MW, y+MH]. The interpolation coordinate calculation part 302 decides the tile numbers of a tile group corresponding to the four corners of the interpolation region, and then also decides that another tile group present among the tile group in the horizontal and vertical directions is a tile group that includes the interpolation region of this time.

The interpolation coordinate calculation part 302 extracts the location (URL or the like) of the interpolation moving images v12 corresponding to each tile number from information transmitted from the interpolation moving image transmission unit 130, and requests reception of the (one or plurality of) interpolation moving images v12 from the extracted location to the reception section 212.

Then, when the reception section 212 receives the (one or plurality of) interpolation moving images v12 transmitted from the interpolation moving image transmission unit 130, the decoding section 216 decodes the received (one or plurality of) interpolation moving images v12, and then delivers (one or a plurality of) frame images of the interpolation moving images v12 having frame numbers to be processed to the interpolation processing section 218 (Step S414).

The time control section 217 performs time matching so that the frame times of the reproduction moving image v10 and the interpolation moving images v12 are synchronized (Step S411 and S414).

The interpolation processing section 218 extracts the pixel group of the interpolation region from the (one or plurality of) frame images of the interpolation moving images v12 (Step S415). The method of extracting the pixel group of the interpolation region in the interpolation processing section 218 is as described above.

The interpolation processing section 218 decides regions from which pixels are extracted within the frame images of the interpolation moving images v12 for each frame of the interpolation moving images v12. The coordinates of the region to be extracted within the moving image screen of each interpolation moving image v12 are [x−(tx×TW), y−(ty×TH)] for the upper-left portion, [x+MW−(tx×TW), y−(ty×TH)] for the upper-right portion, [x−(tx×TW), y+MH−(ty×TH)] for the lower-left portion, and [x+MW−(tx×TW), y+MH−(ty×TH)] for the lower-right portion. It should be noted that the lowest value is 0, and the highest values are TW for the width and TH for the height.

The interpolation processing section 218 connects and then disposes the extracted pixel group on a buffer in the horizontal and/or vertical directions.

The interpolation processing section 218 repeats the processes of Steps S413 to S415 to the end (final frame) of the interpolation moving images v12 (Step S416). By repeating the processes to the end of the interpolation moving images v12, the interpolation processing section 218 can generate the buffer from which the pixel group of the interpolation region from the (one or plurality of) interpolation moving images v12 which is a divided screen group is extracted.

The coordinate systems (coordinates and sizes of images) mentioned hitherto are coordinate systems based on the moving image screen of the high-quality moving image v11, and thus the image magnification change parts 301 and 304 change values of the coordinate systems based on the moving image screen of the high-quality moving image v11 to the coordinate system based on the standard image size thereby converting the coordinates (Steps S412 and S417).

When the change of magnification and conversion of the coordinates are completed, the frame image combination part 305 performs the interpolation process (interpolation process of the interpolation moving images v12 into the reproduction moving image 10) (Step S418).

As the interpolation unit 210 according to Example 3 executes the operation shown in FIG. 31, the interpolation unit can perform the interpolation process in which the pixel group of the interpolation region is extracted from the group of the interpolation moving images v12 which is a moving image group of partial screens that have been divided in advance.

To make the process of Example 3 efficient, the interpolation unit 210 may perform pre-reading of the interpolation moving image v12. In Example 3, there is a case in which (the number of tiles of) the interpolation moving image v12 to be acquired is changed according to a movement in the coordinates of the interpolation region. In such a case, the pre-reading of the interpolation moving image v12 can be performed by using the interpolation information i10 acquired by the interpolation unit 210.

By performing pre-reading of the interpolation information i10, the interpolation unit 210 acquires an interpolation region of the frame time (hereinafter referred to also as a “pre-read time”) (for example, a few seconds) prior to a currently-processed frame, and then decides the interpolation moving image v12 of the tile number corresponding to the region. If the interpolation moving image v12 has not been received yet, the interpolation moving image is set to be received by giving an instruction of reception beforehand, or to be received by making a seek request and skipping unnecessary frames (disposed in the forward direction of the interpolation moving image v12).

The interpolation unit 210 analyzes encoded data of the received interpolation moving image v12 and then places the leading part of a GOP (Group of Pictures) that includes a target frame (frame of the pre-read time) in a reception buffer. When a moving image reproduction time reaches the pre-read time, the interpolation unit 210 performs decoding beginning from the leading part of the GOP, thereby acquiring the target frame image.

After receiving the interpolation moving image v12, the interpolation unit 210 can perform the pre-reading process only by performing network communication and analysis of encoded data (the heading of the GOP or the like) such as seeking without performing a decoding process by the decoding section 216 of the interpolation unit 210. Note that, if there is a decoding section (other than the decoding section 216) that is not used by the interpolation unit 210, the image of the target frame of the pre-acquired interpolation moving image v12 may be extracted using the decoding section that is not yet used.

In the embodiment of the present disclosure described above, adjustment of the transmission rate of the interpolation moving image v12 using MPEG-DASH has been described, however, in Example 3, the adjustment of the transmission rate of the interpolation moving image v12 using MPEG-DASH can be further improved.

In Example 3, different transmission rates may be assigned to a group of the plurality of interpolation moving images v12 (a group of divided-screen moving images) to be acquired. In Example 3, the group of interpolation moving images v12 of the plurality of tiles is acquired according to the coordinates and the size of the interpolation region, however, it is not necessary to set the same encoding rate and transmission rate for all of the plurality of interpolation moving images v12.

For example, importance may be assigned within the group of the plurality of tiles corresponding to the interpolation region such that a high encoding rate with high image quality is assigned to the interpolation moving image v12 of a tile having a high level of importance and a low encoding rate with low image quality is assigned to the interpolation moving image v12 of a tile having a low level of importance. The level of importance of a tile may be decided with, for example, the ratio of the area of the tile to the screen of the interpolation region.

To be specific, the interpolation unit 210 may cause the interpolation moving image v12 of a tile that includes a large number of interpolation regions to have high image quality by assigning a high encoding rate and cause the interpolation moving image v12 of a tile that includes a small number of interpolation regions to have low image quality by assigning a low encoding rate. In addition, for example, the center of the interpolation region is set to have the high level of importance and the level of importance may set to decrease toward the outer side. Accordingly, the interpolation unit 210 can decide a high encoding rate with high image quality for the interpolation moving image v12 of a tile close to the center and a low encoding rate with low image quality for a tile close to the outer side.

According to Example 3, the number of interpolation moving images v12 can be fixed. The interpolation moving image generation unit 120 generates the interpolation moving images v12 of screens divided into a fixed number in advance, rather than creating the interpolation moving images v12 for each interpolation instruction. Thus, even if the number of instructions of interpolation increases, the number of interpolation moving images v12 retained by the interpolation moving image transmission unit 130 may not increase. For this reason, when Example 3 is applied, the capacity of recording moving images in the interpolation moving image transmission unit 130 can be suppressed.

According to Example 3, the interpolation moving images v12 can be created in advance regardless of an interpolation instruction. Since the interpolation moving images v12 are irrelevant to the interpolation instruction, even when a new interpolation instruction is added, a process of generating a new interpolation moving image v12 is not necessary.

In most moving image distribution systems, there is a tendency for investment costs to be allotted to a storage capacity and investment in CPUs and memory costs (the grade and memory capacity of the CPUS or charging per CPU use time in a case of a virtual machine on a cloud) to be suppressed. By applying the technology of Example 3, the process of generating the interpolation moving images v12 is not performed even if the number of instructions of interpolation increases, and thus costs for the CPUs and memories can be suppressed.

According to Example 3, the interpolation moving image v12 corresponding to the interpolation region can be promptly acquired. Since the interpolation moving image v12 are created in advance, when a user of the reproduction device 200 instructs an interpolation region, for example, the interpolation unit 210 can promptly acquire the interpolation moving image v12 based on the instruction. In other words, since a waiting time for the interpolation moving image v12 to be generated in the interpolation moving image generation unit 120 is not necessary, an interactive interpolation process is possible according to Example 3.

### 5. CONCLUSION

As described above, the moving image reproduction system 1 according to the embodiment of the present disclosure can enhance a viewing experience of a user by making a partial image of the reproduction moving image v10 that has low image quality have high image quality.

The moving image reproduction system 1 according to the embodiment of the present disclosure only transmits an interpolation region rather than transmitting an entire moving image with high image quality. Thus, by making a part of an image have high image quality while suppressing a transmission rate and a load to be low, a viewing experience of a user can be enhanced.

In comparison with a technology in which an arithmetic operation for high image quality is performed by analyzing a single moving image, a load caused by the arithmetic operation for high image quality on the reproduction device 200 or a special circuit for high image quality is not necessary in the moving image reproduction system 1 according to the embodiment of the present disclosure. In addition, even if a reproduction moving image has low image quality and a small amount of information, an interpolation moving image can be generated from a high-quality moving image corresponding to the reproduction moving image, and thus the interpolation process performed in the reproduction device 200 for high image quality is not affected. In addition, in comparison with the technology in which an arithmetic operation for high image quality is performed by analyzing a single moving image, the moving image reproduction system 1 according to the embodiment of the present disclosure encodes the interpolation moving image as a separate moving image from the reproduction moving image, and thus can set quality of the interpolation moving image separate from the reproduction moving image. It is not necessary for the moving image reproduction system 1 according to the embodiment of the present disclosure to re-encode (re-create) the reproduction moving image for the arithmetic operation for high image quality performed in the reproduction device 200.

In addition, the moving image reproduction system 1 according to the embodiment of the present disclosure can effectively make use of an unoccupied transmission band during transmission of the reproduction moving image. When a server that includes the reproduction moving image transmission unit 110 provides moving image files of three types of rate and image sizes, the reproduction device 200 selects a moving image file of an available transmission band or a band lower than that. In such a case, there may be room in the transmission band. The moving image reproduction system 1 according to the embodiment of the present disclosure transmits the interpolation moving image by making use of the sufficient transmission band, thereby being able to make an important region in the reproduction screen have high image quality.

Furthermore, the moving image reproduction system 1 according to the embodiment of the present disclosure can make use of a high-quality moving image that is retained by a distributor of the moving image as an original clip, and can lower the transmission rate of an interpolation moving image more than when the entire high-quality moving image is transmitted. In addition, since the moving image reproduction system 1 according to the embodiment of the present disclosure can suppress the image size and the encoding rate of an interpolation moving image to be low, a load on the interpolation processing side can be suppressed.

Moreover, the moving image reproduction system 1 according to the embodiment of the present disclosure can prepare a group of a plurality of interpolation moving images each corresponding to a different region within the screen of one reproduction moving image. By preparing the group of the plurality of interpolation moving images each corresponding to a different region within the screen of one reproduction moving image, when a group of a plurality of reproduction devices interpolates different regions in a reproduction moving image, the reproduction moving image shared by the plurality of reproduction devices and interpolation moving images different according to each of the reproduction devices can be transmitted. For this reason, there are advantages in that it is not necessary for the moving image reproduction system 1 according to the embodiment of the present disclosure to retain an entire moving image screen of high image quality, and by broadcasting the reproduction moving image shared by the plurality of reproduction devices for distribution, a recording capacity of moving image data of a moving image transmission side can be reduced. In addition, there is another advantage that, by broadcasting the reproduction moving image shared by the plurality of reproduction devices for distribution, the moving image reproduction system 1 according to the embodiment of the present disclosure can improve transmission efficiency.

By applying Example 1 described above, the moving image reproduction system 1 according to the embodiment of the present disclosure can set an encoding rate and transmission rate of an interpolation moving image to be a required minimum level by setting a required minimum image size thereof in which an interpolation region is included. In addition, by setting the required minimum encoding rate and transmission rate, the interpolation process (the decoding process and a process on a frame image) performed by the interpolation unit 210 is also reduced. Thus, by applying Example 1 described above, the moving image reproduction system 1 according to the embodiment of the present disclosure can have a flexible configuration in which, even though there is only one hardware decoder, the hardware decoder is used in decoding a reproduction moving image and a software decoder is used in decoding an interpolation moving image.

By applying Example 1 described above, the moving image reproduction system 1 according to the embodiment of the present disclosure can associate interpolation regions with interpolation moving images one to one to facilitate combinations of a plurality of interpolation patterns. For example, when player A and player B are to be interpolated, an interpolation moving image A for interpolating player A and an interpolation moving image B for interpolating player B may be acquired, and when player A and player C are to be interpolated, the interpolation moving image A and an interpolation moving image C for interpolating player C may be acquired.

By applying Example 2 described above, the moving image reproduction system 1 according to the embodiment of the present disclosure can cause the images of a plurality of interpolation regions to be included in one interpolation moving image screen. By causing the images of a plurality of interpolation regions to be included in one interpolation moving image screen, the images of a plurality of interpolation regions can be extracted at once with decoding of the interpolation moving image by one decoder during the interpolation process, and even if there are the plurality of interpolation regions, it is not necessary to perform decoding once for each of the interpolation regions. Furthermore, by applying Example 2 described above, one time of streaming of an interpolation moving image is possible in the moving image reproduction system 1 according to the embodiment of the present disclosure. Moreover, by applying Example 2 described above, the moving image reproduction system 1 according to the embodiment of the present disclosure can express an interpolation region in a shape other than a rectangle.

Furthermore, by applying Example 1 and Example 2 described above, the moving image reproduction system 1 according to the embodiment of the present disclosure can express an interpolation region in a shape other than a rectangle even in Example 1 and can reduce an amount of information of an interpolation moving image after its encoding.

By applying Example 3 described above, in the moving image reproduction system 1 according to the embodiment of the present disclosure, a group of interpolation moving images (a group of moving images of partial screens) is not affected by interpolation patterns, and thus can be created prior to the interpolation process. In Example 3 described above, the number of interpolation moving images is fixed as long as a division pattern is not changed, it is not necessary to generate interpolation moving images for each interpolation pattern, and only interpolation information may be created. For this reason, by applying Example 3 described above, even if the number of interpolation patterns increases in the moving image reproduction system 1 according to the embodiment of the present disclosure, the number of interpolation moving images to be retained by the interpolation moving image transmission unit 130 may not be increased, and thus the capacity of the moving image file storage region is suppressed.

By applying Example 3 described above, it is not necessary for the moving image reproduction system 1 according to the embodiment of the present disclosure to generate interpolation moving images every time an interpolation instruction is added, and thus investment costs for a CPU and a memory of a server that distributes the moving images can be suppressed. By applying Example 3 described above, the moving image reproduction system 1 according to the embodiment of the present disclosure creates the interpolation moving images in advance, and thus if a new interpolation pattern (interpolation instruction) is created, the reproduction device 200 promptly acquires the interpolation moving images and performs interpolation-combination. By applying Example 3 described above, the moving image reproduction system 1 according to the embodiment of the present disclosure can perform interactive interpolation because a waiting time for the interpolation moving images to be generated in the interpolation moving image generation unit 120 is not necessary.

The respective steps in the processing executed by the various apparatuses described in the present disclosure do not have to be performed in chronological order according to the order described as a sequence diagram or flowchart. For example, the respective steps in the processing executed by the various apparatuses can be carried out in a different order to that described in the flowcharts, or can be carried out in parallel.

In addition, a computer program can be created that makes hardware, such as a CPU, ROM, and RAM, in the various apparatuses realize functions equivalent to the parts of the various above-described apparatuses. Still further, a storage medium on which such a computer program is stored can also be provided. Moreover, series of processes can also be realized by hardware by configuring the respective function blocks illustrated in the function block diagrams as hardware.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) A video processing device including:

an image generation unit configured to generate a second moving image configured to have the same content as a first moving image having first image quality, to have second image quality configured to be higher quality than the first image quality, and to have a size corresponding to a partial region of the first moving image; and

a reproduction information generation unit configured to generate reproduction information configured to be used to simultaneously reproduce the first moving image and the second moving image after a portion of the first moving image is replaced with the second moving image.

(2) The video processing device according to (1), wherein the image generation unit decides a region of the second moving image based on the reproduction information generated by the reproduction information generation unit.

(3) The video processing device according to (2), wherein the image generation unit generates a moving image having a same content as a moving image of the decided region with the second image quality for a pixel group configured to include the decided region during the period in which the first moving image and the second moving image are simultaneously reproduced.

(4) The video processing device according to (2), wherein the image generation unit generates a moving image having a same content as a moving image of the decided region with the second image quality for the decided region, and generates invalid pixels for the region other than the decided region.

(5) The video processing device according to (4), wherein the image generation unit generates the moving image having a same content as the moving image of the decided region with the second image quality for the decided region for a pixel group configured to include the decided region during the period in which the first moving image and the second moving image are simultaneously reproduced, and generates the invalid pixels for the region other than the decided region.

(6) The video processing device according to (2), wherein the image generation unit generates a moving image having the same content as a moving image of the decided region with the second image quality for a predetermined block among blocks divided into a plurality of regions as the decided region.

(7) The video processing device according to any one of (1) to (6), wherein the image generation unit generates the second moving image for a region in which recognition of the content of the first moving image is enhanced during reproduction of the first moving image.

(8) The video processing device according to (7), wherein the region is a region in the first moving image, the region including appearance of a person.

(9) The video processing device according to (7) or (8), wherein the region is a region in the first moving image, the region displaying text information.

(10) The video processing device according to any one of (1) to (9), wherein the image generation unit automatically generates, on a basis of the reproduction information, the second moving image from a third moving image configured to serve as a base of the second moving image.

(11) A video reproduction device including:

an image acquisition unit configured to acquire a first moving image configured to have first image quality, a second moving image configured to have a same content as the first moving image, to have second image quality configured to be higher quality than the first image quality, and to have a size corresponding to a partial region of the first moving image, and reproduction information used to simultaneously reproduce the first moving image and the second moving image after a portion of the first moving image is replaced with the second moving image; and

an image combining unit configured to cause the first moving image and the second moving image to be simultaneously reproduced after the portion of the first moving image is replaced with the second moving image based on the reproduction information acquired by the image acquisition unit.

(12) The video reproduction device according to (11), wherein the image combining unit includes an image extraction unit configured to extract, from the second moving image, a region to be replaced with the portion of the first moving image.

(13) The video reproduction device according to (12), wherein the image combining unit acquires the reproduction information and the second moving image, to the reproduction information including information on the region extracted by the image extraction unit.

(14) The video reproduction device according to any one of (11) to (13), wherein the image acquisition unit acquires the first moving image from a device different from a device configured to transmit the second moving image.

(15) The video reproduction device according to any one of (11) to (13), wherein the image acquisition unit acquires the first moving image from a same device as a device configured to transmit the second moving image.

(16) A video processing method including:

generating a second moving image configured to have a same content as a first moving image having first image quality, to have second image quality configured to be higher quality than the first image quality, and to have a size corresponding to a partial region of the first moving image; and

generating reproduction information used to simultaneously reproduce the first moving image and the second moving image after a portion of the first moving image is replaced with the second moving image.

(17) A video reproduction method including:

acquiring a first moving image configured to have first image quality, a second moving image configured to have a same content as the first moving image, to have second image quality configured to be higher quality than the first image quality, and to have a size corresponding to a partial region of the first moving image, and reproduction information used to simultaneously reproduce the first moving image and the second moving image after a portion of the first moving image is replaced with the second moving image; and

simultaneously reproducing the first moving image and the second moving image after the portion of the first moving image is replaced with the second moving image based on the reproduction information acquired in the acquisition step.

(18) A video processing system including:

a video processing device; and

a video reproduction device,

wherein the video processing device includes
an image generation unit configured to generate a second moving image configured to have a same content as a first moving image having first image quality, to have second image quality configured to be higher quality than the first image quality, and to have a size corresponding to a partial region of the first moving image, and
a reproduction information generation unit configured to generate reproduction information used to simultaneously reproduce the first moving image and the second moving image after a portion of the first moving image is replaced with the second moving image, and

wherein the video reproduction device includes
an image acquisition unit configured to acquire at least the second moving image and the reproduction information from the video processing device, and
an image reproduction unit configured to simultaneously reproduce the first moving image and the second moving image after the portion of the first moving image is replaced with the second moving image based on the reproduction information acquired by the image acquisition unit.

What is claimed is:

1. A video processing device comprising:
an image generation unit configured to generate a second moving image configured to have the same content as a first moving image having first image quality, to have second image quality configured to be higher quality than the first image quality, and to have a size corresponding to a partial region of the first moving image; and
a reproduction information generation unit configured to generate reproduction information configured to be used to simultaneously reproduce the first moving image and the second moving image after a portion of the first moving image is replaced with the second moving image.

2. The video processing device according to claim 1, wherein the image generation unit decides a region of the second moving image based on the reproduction information generated by the reproduction information generation unit.

3. The video processing device according to claim 2, wherein the image generation unit generates a moving image having a same content as a moving image of the decided region with the second image quality for a pixel group configured to include the decided region during the period in which the first moving image and the second moving image are simultaneously reproduced.

4. The video processing device according to claim 2, wherein the image generation unit generates a moving image having a same content as a moving image of the decided region with the second image quality for the decided region, and generates invalid pixels for the region other than the decided region.

5. The video processing device according to claim 4, wherein the image generation unit generates the moving image having a same content as the moving image of the decided region with the second image quality for the decided region for a pixel group configured to include the decided region during the period in which the first moving image and the second moving image are simultaneously reproduced, and generates the invalid pixels for the region other than the decided region.

6. The video processing device according to claim 2, wherein the image generation unit generates a moving image having the same content as a moving image of the decided region with the second image quality for a predetermined block among blocks divided into a plurality of regions as the decided region.

7. The video processing device according to claim 1, wherein the image generation unit generates the second moving image for a region in which recognition of the content of the first moving image is enhanced during reproduction of the first moving image.

8. The video processing device according to claim 7, wherein the region is a region in the first moving image, the region including appearance of a person.

9. The video processing device according to claim 7, wherein the region is a region in the first moving image, the region displaying text information.

10. The video processing device according to claim 1, wherein the image generation unit automatically generates, on a basis of the reproduction information, the second moving image from a third moving image configured to serve as a base of the second moving image.

11. A video reproduction device comprising:
an image acquisition unit configured to acquire a first moving image configured to have first image quality, a second moving image configured to have a same content as the first moving image, to have second image quality configured to be higher quality than the first image quality, and to have a size corresponding to a partial region of the first moving image, and reproduction information used to simultaneously reproduce the first moving image and the second moving image after a portion of the first moving image is replaced with the second moving image; and
an image combining unit configured to cause the first moving image and the second moving image to be simultaneously reproduced after the portion of the first moving image is replaced with the second moving image based on the reproduction information acquired by the image acquisition unit.

12. The video reproduction device according to claim 11, wherein the image combining unit includes an image extraction unit configured to extract, from the second moving image, a region to be replaced with the portion of the first moving image.

13. The video reproduction device according to claim 12, wherein the image combining unit acquires the reproduction information and the second moving image, to the reproduction information including information on the region extracted by the image extraction unit.

14. The video reproduction device according to claim 11, wherein the image acquisition unit acquires the first moving image from a device different from a device configured to transmit the second moving image.

15. The video reproduction device according to claim 11, wherein the image acquisition unit acquires the first moving image from a same device as a device configured to transmit the second moving image.

16. A video processing method comprising:
generating a second moving image configured to have a same content as a first moving image having first image quality, to have second image quality configured to be higher quality than the first image quality, and to have a size corresponding to a partial region of the first moving image; and
generating reproduction information used to simultaneously reproduce the first moving image and the second moving image after a portion of the first moving image is replaced with the second moving image.

17. A video reproduction method comprising:
acquiring a first moving image configured to have first image quality, a second moving image configured to have a same content as the first moving image, to have second image quality configured to be higher quality than the first image quality, and to have a size corresponding to a partial region of the first moving image, and reproduction information used to simultaneously reproduce the first moving image and the second moving image after a portion of the first moving image is replaced with the second moving image; and
simultaneously reproducing the first moving image and the second moving image after the portion of the first moving image is replaced with the second moving image based on the reproduction information acquired in the acquisition step.

18. A video processing system comprising:
a video processing device; and
a video reproduction device,
wherein the video processing device includes
an image generation unit configured to generate a second moving image configured to have a same content as a first moving image having first image quality, to have second image quality configured to be higher quality than the first image quality, and to have a size corresponding to a partial region of the first moving image, and
a reproduction information generation unit configured to generate reproduction information used to simultaneously reproduce the first moving image and the second moving image after a portion of the first moving image is replaced with the second moving image, and
wherein the video reproduction device includes
an image acquisition unit configured to acquire at least the second moving image and the reproduction information from the video processing device, and
an image reproduction unit configured to simultaneously reproduce the first moving image and the second moving image after the portion of the first moving image is replaced with the second moving image based on the reproduction information acquired by the image acquisition unit.
